(19) United States
(12) Patent Application Publication
(10) Pub. No.: US 2025/0061748 A1
(43) Pub. Date: Feb. 20, 2025

(54) DATA AUGMENTATION OF MOTION TRAJECTORIES AND SYNTHESIS OF EM SIGNATURES FOR ML-BASED HUMAN GESTURE RECOGNITION AND ACTIVITY DETECTION

(71) Applicant: Samsung Electronics Co., Ltd., Suwon-si (KR)

(72) Inventors: Indranil Sinharoy, Richardson, TX (US); Aditya Dave, Plano, TX (US); Vutha Va, Plano, TX (US); Lianjun Li, McKinney, TX (US); Hao Chen, Allen, TX (US); Gaurav Duggal, Blacksburg, VA (US)

(21) Appl. No.: 18/803,301

(22) Filed: Aug. 13, 2024

Related U.S. Application Data
(60) Provisional application No. 63/532,629, filed on Aug. 14, 2023.

(51) Int. Cl. G06V 40/20; G01S 13/62; G06T 7/246; G06V 10/774

(52) U.S. Cl. CPC G06V 40/28; G01S 13/62; G06T 7/246; G06V 10/774; G06T 2207/20081; G06T 2207/30196; G06T 2207/30204; G06T 2207/30241

(57) ABSTRACT

Methods and systems for human gesture recognition and activity detection using augmented data. A computer-implemented method includes receiving motion capture data of a target from a camera, generating a first set of motion trajectories from the motion capture data, generating a first set of augmented motion trajectories using a set of data augmentation functions on the first set of motion trajectories, generating a radar cross-section of the target using the motion capture data to perform at least one of gesture recognition or activity detection, generating one or more synthetic electromagnetic (EM) signatures of one or more activities of the target using the first set of augmented motion trajectories and the radar cross-section, and training a machine learning model configured for EM signature-based gesture recognition or activity detection with a domain adaptation process using the one or more synthetic EM signatures.

### CROSS-REFERENCE TO RELATED APPLICATIONS AND CLAIM OF PRIORITY

The present application claims priority to U.S. Provisional Patent Application No. 63/532,629, filed on Aug. 14, 2023. The contents of the above-identified patent documents are incorporated herein by reference.

### TECHNICAL FIELD

The present disclosure relates generally to wireless communication systems and, more specifically, the present disclosure relates to a system and method for human gesture recognition and activity detection.

### BACKGROUND

Gesture recognition and activity detection systems typically vision-based and use a camera and motion sensor to track user movements. However, these systems raise privacy concerns for users. As such, there is an increasing interest in using electromagnetic (EM) signals, such as millimeter wave (mmWave) radar, ultra-wide band (UWB) radar, and wireless fidelity (Wi-Fi), for human gesture recognition and activity detection. These modalities address privacy concerns regarding video capture systems while also providing accurate detection and recognition capability, particularly when coupled with machine learning (ML) algorithms.

However, there is a lack of real EM signature data, e.g. Doppler and micro-Doppler signatures from mmWave or UWB radar, limiting the accuracy and precision potential of ML algorithms for a variety of detection and recognition of tasks. Accordingly, there is a need for systems and methods for improved human gesture recognition and activity detection based on EM modalities that overcome these challenges.

### SUMMARY

The present disclosure relates generally to wireless communication systems and, more specifically, the present disclosure relates to a system and method for human gesture recognition and activity detection.

In one embodiment, a computer-implemented method is provided. The computer-implemented method includes receiving motion capture data of a target from a camera, generating a first set of motion trajectories from the motion capture data, generating a first set of augmented motion trajectories using a set of data augmentation functions on the first set of motion trajectories, generating a radar cross-section of the target using the motion capture data to perform at least one of gesture recognition or activity detection, generating one or more synthetic electromagnetic (EM) signatures of one or more activities of the target using the first set of augmented motion trajectories and the radar cross-section, and training a machine learning model configured for EM signature-based gesture recognition or activity detection with a domain adaptation process using the one or more synthetic EM signatures.

In another embodiment, a gesture recognition and activity detection system is provided. The gesture recognition and activity detection system includes at least one camera configured for motion capture and a controller coupled to the at least one camera. The controller is configured to receive motion capture data of a target from the at least one camera, generate a first set of motion trajectories from the motion capture data, generate a first set of augmented motion trajectories using a set of data augmentation functions on the first set of motion trajectories, generate a radar cross-section of the target using the motion capture data to perform at least one of gesture recognition or activity detection, generate one or more synthetic electromagnetic (EM) signatures of one or more activities of the target using the first set of augmented motion trajectories and the radar cross-section, and train a machine learning model configured for EM signature-based gesture recognition or activity detection with a domain adaptation process using the one or more synthetic EM signatures.

In yet another embodiment, a non-transitory computer-readable medium is provided. The non-transitory computer-readable medium includes program code, that when executed by at least one processor of an electronic device, causes the electronic device to receive motion capture data of a target from a camera, generate a first set of motion trajectories from the motion capture data, generate a first set of augmented motion trajectories using a set of data augmentation functions on the first set of motion trajectories, generate a radar cross-section of the target using the motion capture data to perform at least one of gesture recognition or activity detection, generate one or more synthetic electromagnetic (EM) signatures of one or more activities of the target using the first set of augmented motion trajectories and the radar cross-section, and train a machine learning model configured for EM signature-based gesture recognition or activity detection with a domain adaptation process using the one or more synthetic EM signatures.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2 illustrates an example electronic device according to various embodiments of the present disclosure;

FIG. 3 illustrates another example of an electronic device in accordance with various embodiments of this disclosure;

FIG. 4 illustrates an example monostatic radar according to embodiments of the present disclosure;

FIG. 5 illustrates an example of a flow chart for a method of generating a large set of synthetic electromagnetic (EM) scatter signals encoding activities from a smaller set of motion capture trajectories according to various embodiments of the present disclosure;

FIG. 6A illustrates an example of a system for recording activity motion trajectories according to various embodiments of the present disclosure;

FIG. 6B illustrates an example of markers for recording the motion trajectories of the different parts of a target according to various embodiments of the present disclosure;

FIG. 7A illustrates an example of depth coordinates of a target rigid body marker trajectories for a left to right swipe gesture according to various embodiments of the present disclosure;

FIG. 7B illustrates an example of height coordinates of the rigid body marker trajectories for a left to right swipe gesture according to various embodiments of the present disclosure;

FIG. 7C illustrates an example of planar coordinates of rigid body markers over time along with the polygons of the target rigid body and radar cross-section for a left to right swipe gesture according to various embodiments of the present disclosure;

FIG. 7D illustrates an example of features computed from synthetic EM scatter signals for a left to right swipe gesture according to various embodiments of the present disclosure;

FIG. 8A illustrates an example of depth coordinates of a target rigid body marker trajectories for a tap gesture according to various embodiments of the present disclosure;

FIG. 8B illustrates an example of height coordinates of the rigid body marker trajectories for a tap gesture according to various embodiments of the present disclosure;

FIG. 8C illustrates an example of planar coordinates of rigid body markers over time along with the polygons of the target rigid body and radar cross-section for a tap gesture according to various embodiments of the present disclosure;

FIG. 8D illustrates an example of features computed from synthetic EM scatter signals for a tap gesture according to various embodiments of the present disclosure;

FIGS. 9A, 9B, 9C, and 9D illustrate examples of a time-varying radar cross-section for a planar rigid body at different orientations according to various embodiments of the present disclosure;

FIG. 10 illustrates an example of a flowchart showing a method for data augmentation to synthesize a dataset of EM scatter signals according to various embodiments of the present disclosure;

FIGS. 11A, 11B, 11C, 11D, and 11E illustrate an example of data augmentation transforms on motion capture trajectories according to various embodiments of the present disclosure;

FIG. 12 illustrates an example of a varying trajectory curvature using fourth order Bezier curve interpolation according to various embodiments of the present disclosure;

FIGS. 13A and 13B illustrate an example of a framework for constructing a data augmentation pipeline according to various embodiments of the present disclosure;

FIG. 14A illustrates an example of trajectories of target marker positions on x-y plane and polygons joining the target markers according to various embodiments of the present disclosure;

FIG. 14B illustrates an example of y-coordinates of marker trajectories over time during the pre-gesture and gesture period according to various embodiments of the present disclosure;

FIG. 14C illustrates an example of trajectories after data augmentation of target marker positions on x-y plane and polygons joining the target markers according to various embodiments of the present disclosure;

FIG. 14D illustrates an example of y-coordinates of marker trajectories after data augmentation over time during the pre-gesture and gesture period according to various embodiments of the present disclosure;

FIG. 15A illustrates an example of z-coordinates of marker trajectories over time according to various embodiments of the present disclosure;

FIG. 15B illustrates an example of y-coordinates of marker trajectories over time according to various embodiments of the present disclosure;

FIG. 15C illustrates an example of z-coordinates of marker trajectories over time after data augmentation according to various embodiments of the present disclosure;

FIG. 15D illustrates an example of y-coordinates of marker trajectories over time after data augmentation according to various embodiments of the present disclosure;

FIG. 16 illustrates an example of a flow chart for a method of generating a synthetic EM scatter signals encoding a variety of activities from motion capture trajectories according to various embodiments of the present disclosure;

FIG. 17A illustrates an example of a system for synchronously capturing activity motion trajectories concurrently with real EM signatures using a radio frequency (RF) module according to various embodiments of the present disclosure;

FIG. 17B illustrates an example of markers on a target for recording the motion trajectories for use in the system of FIG. 17A according to various embodiments of the present disclosure;

FIGS. 18A, 18B, 18C, and 18D illustrate an example of qualitative comparison of real and synthetic time-velocity diagram and time-angle diagram for a left-to-right swipe gesture according to various embodiments of the present disclosure;

FIGS. 19A, 19B, 19C, and 19D illustrate an example of qualitative comparison of real and synthetic time-velocity diagram and time-angle diagram for a tap gesture according to various embodiments of the present disclosure; and

FIG. 20 illustrates an example of a flow chart for a domain adaptation process using synthesized data from a data augmentation process according to various embodiments of the present disclosure.

### DETAILED DESCRIPTION

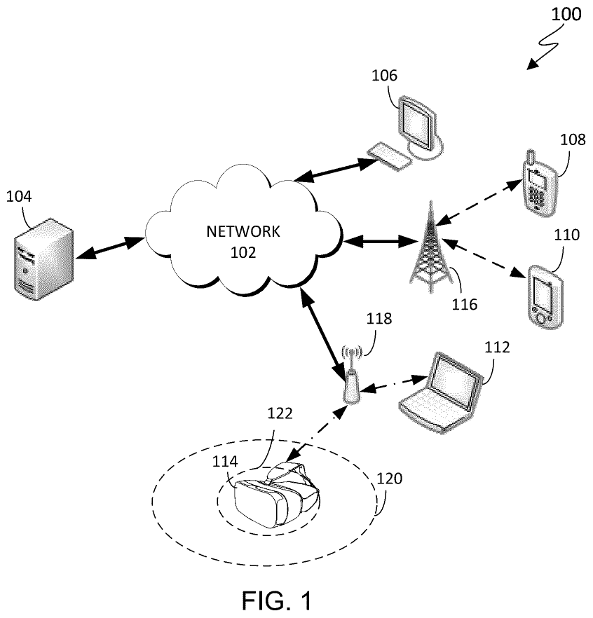

FIG. 1 through FIG. 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates an example communication system according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, AR/VR glasses, a television, an audio playback system or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and AR/VR glasses 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can emit and collect radar signals via a radar transceiver. In certain embodiments, the client devices 106-114 are able to sense the presence of an object located close to the client device and determine whether the location of the detected object is within a first area 120 or a second area 122 closer to the client device than a remainder of the first area 120 that is external to the second area 122. In certain embodiments, the boundary of the second area 122 is at a predefined proximity (e.g., 5 centimeters away) that is closer to the client device than the boundary of the first area 120, and the first area 120 can be a within a different predefined range (e.g., 30 meters away) from the client device where the user is likely to perform a gesture.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

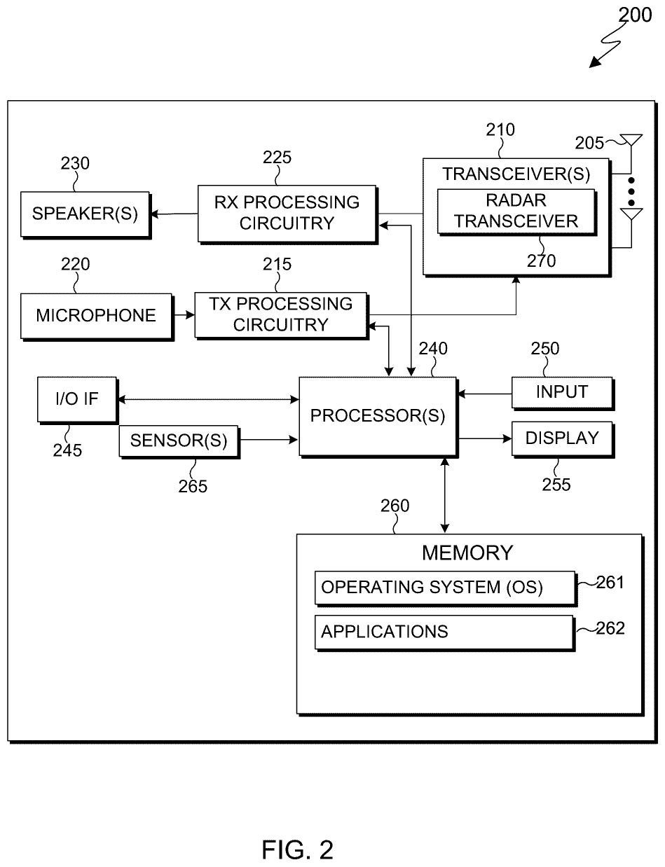

FIG. 2 illustrates an example electronic device according to embodiments of the present disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the AR/VR glasses 114 of FIG. 1), a non-portable electronic device such as a television or an audio playback system, a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. As described in greater detail below, the processor 240 may execute processes to support or perform data augmentation of motion trajectories and synthesis of EM signatures to improve performance of ML-based human gesture recognition and activity detection systems for the implementation of methods described herein. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHZ, 7 GHZ, 8 GHZ, 28 GHZ, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

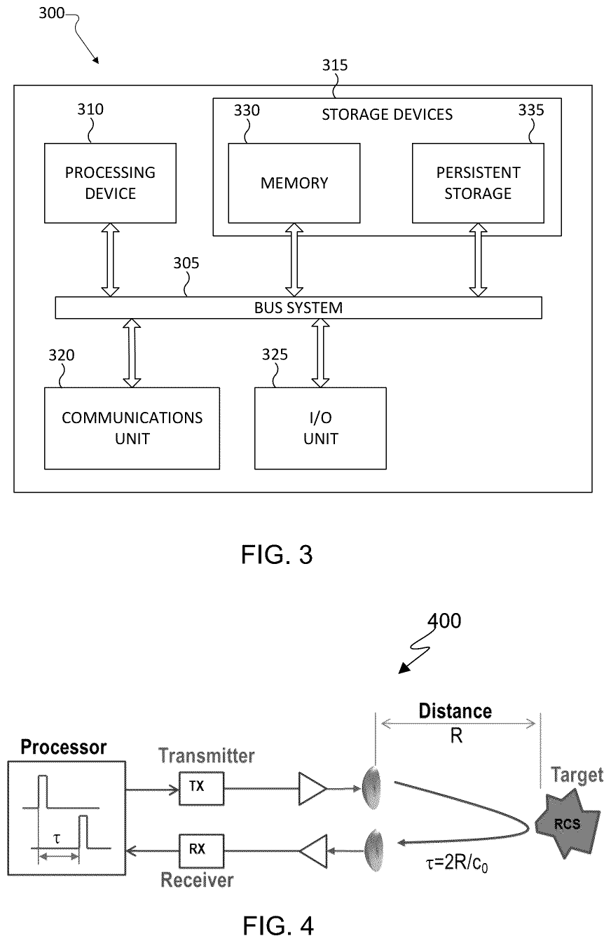

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 3, below, illustrates an example monostatic radar.

In certain embodiments, the radar transceiver 270 can include a transmitter and a receiver. In the radar transceiver 270, the transmitter of can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200. Based on the time differences, the processor 240 can generate an image of the object by mapping the various distances.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

FIG. 3 illustrates another example of an electronic device 300 in accordance with various embodiments of this disclosure. In one embodiment, the electronic device 300 is a server, such as server 104 in FIG. 1 or a client device, such as one of client devices 106-114 in FIG. 1.

As shown in FIG. 3, the electronic device 300 includes a bus system 305, which supports communication between at least one processor 310, at least one storage device 315, at least one communications unit 320, and at least one input/output (I/O) unit 325. The processor 310 executes instructions that may be loaded into a memory 330. The processor 310 may include any suitable number(s) and type(s) of processors or other devices in any suitable arrangement. Examples of types of processor 310 include microprocessors, microcontrollers, digital signal processors, field programmable gate arrays, application specific integrated circuits, and discreet circuitry.

The memory 330 and a persistent storage 335 are examples of storage devices 315, which represent any structure(s) capable of storing and facilitating retrieval of information (such as data, program code, and/or other suitable information on a temporary or permanent basis). The memory 330 may represent a random-access memory or any other suitable volatile or non-volatile storage device(s). The persistent storage 335 may contain one or more components or devices supporting longer-term storage of data, such as a ready only memory, hard drive, flash memory, or optical disc.

The communications unit 320 supports communications with other systems or devices. For example, the communications unit 320 could include a network interface card or a wireless transceiver facilitating communications over the network 130. The communications unit 320 may support communications through any suitable physical or wireless communication link(s).

The I/O unit 325 allows for input and output of data. For example, the I/O unit 325 may provide a connection for user input through a keyboard, mouse, keypad, touchscreen, or other suitable input device. The I/O unit 325 may also send output to a display, printer, or other suitable output device.

As described in more detail below, the electronic device 300 can be used to perform data augmentation of motion trajectories and synthesis of EM signatures to improve performance of ML-based human gesture recognition and activity detection systems for the implementation of methods described herein, especially in situations where real-time data is not necessary or, on the other hand, where the calculations are more efficiently or effectively done by the electronic device 300. The electronic device 300 could also maintain or determine any data or calculations that can be done offline and then transmitted to another component in network 100.

A common type of radar is the “monostatic” radar, characterized by the fact that the transmitter of the radar signal and the receiver for its delayed echo are, for all practical purposes, in the same location.

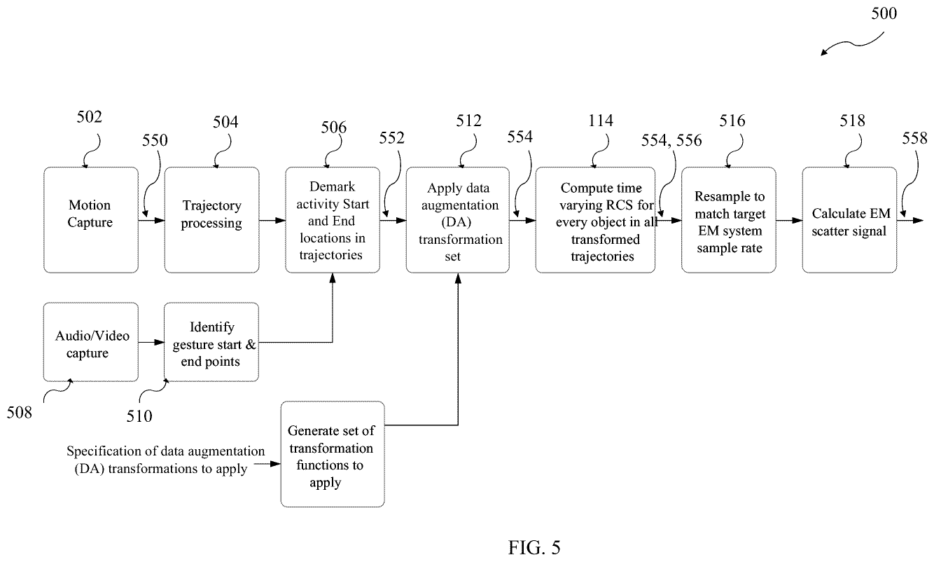

FIG. 4 illustrates an example monostatic radar 400 according to embodiments of the present disclosure. The embodiment of a monostatic radar 400 of FIG. 4 is for illustration only. Different embodiments of a monostatic radar 400 could be used without departing from the scope of this disclosure.

In the example of FIG. 4, a high level architecture is shown for a common monostatic radar, i.e., the transmitter and receiver are co-located, either by using a common antenna, or are nearly co-located, while using separate, but adjacent antennas. Monostatic radars are assumed coherent, i.e., transmitter and receiver are synchronized via a common time reference.

In a monostatic radar's most basic form, a radar pulse is generated as a realization of a desired “radar waveform”, modulated onto a radio carrier frequency and transmitted through a power amplifier and antenna (shown as a parabolic antenna), either omni-directionally or focused into a particular direction. Assuming a “target” at a distance R from the radar location and within the field-of-view of the transmitted signal, the target will be illuminated by RF power density pₜ (in units of W/m²) for the duration of the transmission. The first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where:
P_{T} . . . transmit power [W],
G_{T}, A_{T} . . . transmit antenna gain [dBi], effective aperture area [m²],
λ . . . wavelength of the radar signal RF carrier signal [m],
R . . . target distance [m].
   In this example, effects of atmospheric attenuation, multi-path propagation, antenna losses, etc. have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver, so only direct reflections will contribute to a detectable receive signal. In essence, the illuminated area(s) of the target with normal vectors pointing back at the receiver will act as transmit antenna apertures with directivities (gains) in accordance with their effective aperture area(s). The reflected-back power is:

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} RCS ,$$

where:

P_{refl} . . . effective (isotropic) target-reflected power [W],
Aₜ, rₜ, Gₜ . . . effective target area normal to the radar direction [m²], reflectivity of the material & shape [0, . . . , 1], and corresponding aperture gain [dBi],
RCS . . . Radar Cross Section [m²].

Note that the radar cross section, RCS, is an equivalent area that scales proportionally to the actual reflecting area-squared, inversely proportionally with the wavelength-squared and is reduced by various shape factors and the reflectivity of the material. For a flat, fully reflecting mirror of area Aₜ, large compared with λ², RCS=4πAₜ²/λ². Due to the material and shape dependency, it is generally not possible to deduce the actual physical area of a target from the reflected power, even if the target distance is known.

The target-reflected power at the receiver location results from the reflected-power density at the reverse distance R, collected over the receiver antenna aperture area:

$${P}_{R} = \frac{{P}_{refl}}{4 π {R}^{2}} {A}_{R} = {P}_{T} \cdot RCS \frac{{A}_{T} {A}_{R}}{4 {πλ}^{2} {R}^{4}} ,$$

where:
P_{R} . . . received, target-reflected power [W],
A_{R} . . . receiver antenna effective aperture area [m²], may be same as A_{T}.
   The radar system is usable as long as the receiver signal exhibits sufficient signal-to-noise ratio (SNR), the particular value of which depends on the waveform and detection method used. Generally, in a simpler form:

$$SNR = \frac{{P}_{R}}{kT \cdot B \cdot F} ,$$

where:
kT . . . Boltzmann's constant×temperature [W/Hz],
B . . . radar signal bandwidth [Hz],
F . . . receiver noise factor (degradation of receive signal SNR due to noise contributions of the receiver circuit itself).

In case the radar signal is a short pulse of duration (width) T_{P}, the delay τ between the transmission and reception of the corresponding echo will be equal to τ=2R/c, where c is the speed of (light) propagation in the medium (air). In case there are several targets at slightly different distances, the individual echoes can be distinguished as such only if the delays differ by at least one pulse width, and hence the range resolution of the radar will be ΔR=cΔτ/2=cT_{P}/2. Further considering that a rectangular pulse of duration T_{P} exhibits a power spectral density P(f)˜(sin(πfT_{P})/(πfT_{P}))² with the first null at its bandwidth B=1/T_{P}, the range resolution of a radar is fundamentally connected with the bandwidth of the radar waveform via:

$$Δ R = c / 2 B .$$

Although FIG. 4 illustrates an example of a monostatic radar 400, various changes may be made to FIG. 4. For example, various changes to transmitter, the receiver, the processor, etc. could be made according to particular needs.

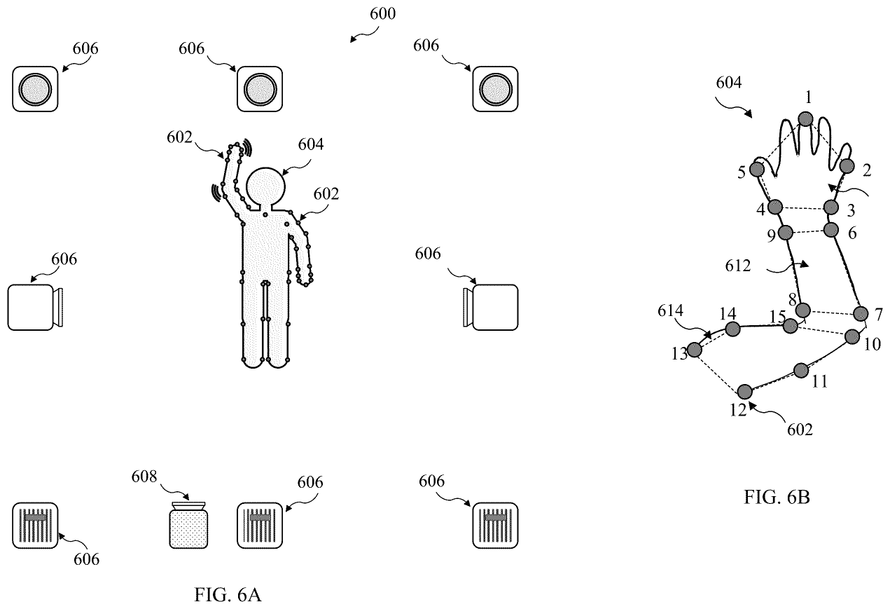

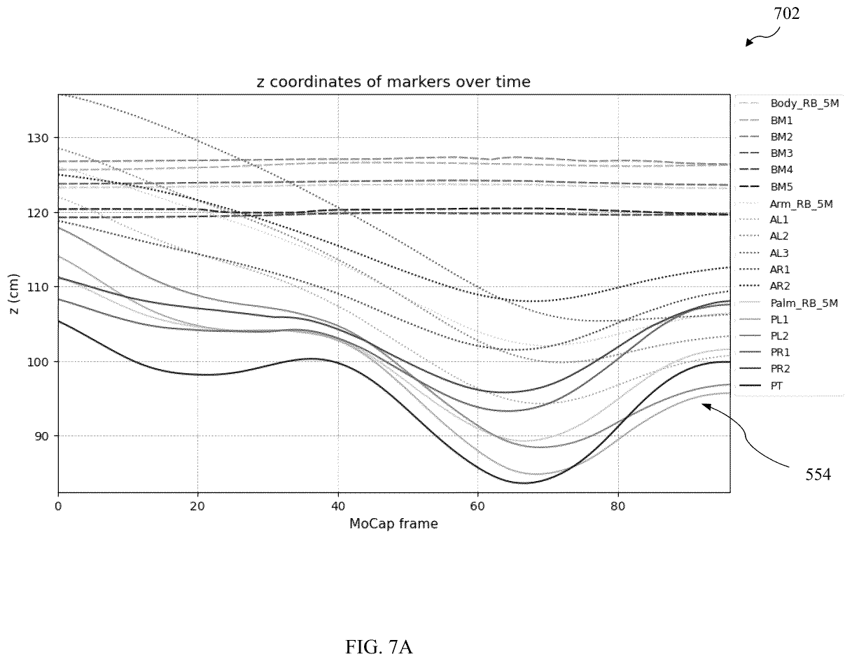

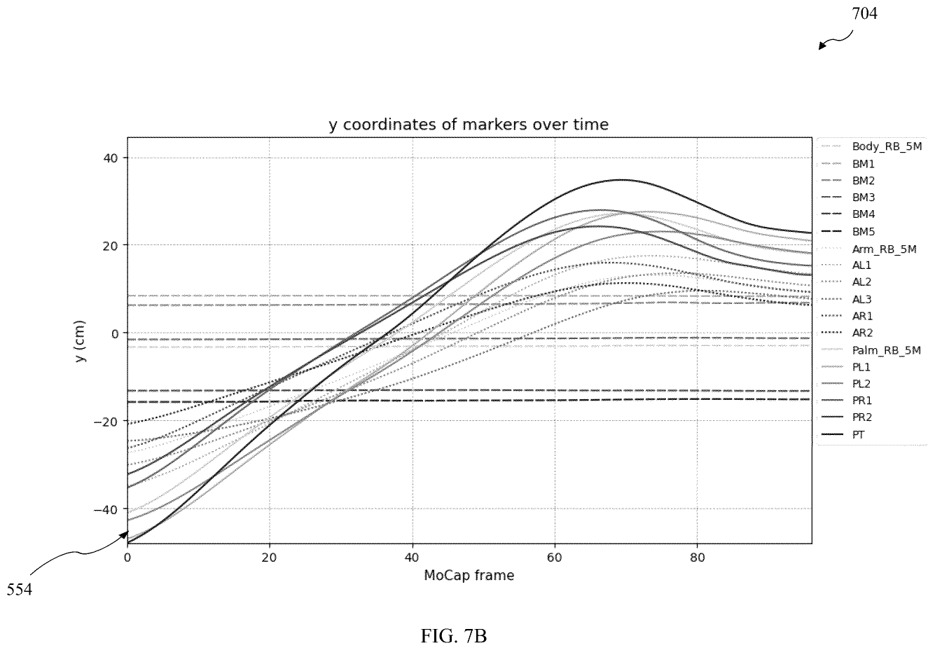

FIG. 5 illustrates an example of a flow chart for a method of generating a large set of synthetic EM scatter signals encoding activities from a smaller set of motion capture trajectories according to various embodiments of the present disclosure. For example, the method shown in the flow chart of FIG. 5 may be executed by a gesture recognition and activity detection system 600 for obtaining these small set of motion capture trajectories. FIG. 6A illustrates an example of gesture recognition and activity detection system 600 for recording activity motion trajectories according to various embodiments of the present disclosure. FIG. 6B illustrates an example of markers for recording the motion trajectories while using the gesture recognition and activity detection system 600 according to various embodiments of the present disclosure. The term “activities” may include but are not limited to hand gestures, walking, sitting, running, exercising, and other usually non-intentional events, such as falling, that may be of interest for monitoring.

The gesture recognition and activity detection system 600 may be an electronic device or an electronic device system. For example, the gesture recognition and activity detection system 600 may include any electronic device having a process, such as optical media players (e.g., a digital versatile disc (DVD) player, a Blu-ray player, an ultra-high-definition (UHD) player), a smart appliance, a set-top box, a television, a personal computer, a mobile device, a game console device, a content server, a smart device, a streaming device, or combination thereof. Additionally, the gesture recognition and activity detection system 600 may be a portable electronic device or electronic system. For example, may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband or hung around the neck of the user using a lanyard.

In operation 502, the gesture recognition and activity detection system 600 collects motion capture data used for creating motion capture trajectories 550. The motion capture trajectories 550 are time series of 3D positions of a subset of objects or marked points on objects in the scene, including but not limited to points on a human body performing some activity or points on static or dynamic rigid objects in the scene. In other words, the motion capture trajectories 550 record and describe the motion or path of these points in 3D space as a function of time. In some embodiments, some or all the marked points tracked may be grouped to form at least one marker group that is approximated as at least one planar target and each marker includes a position in the alt least one planar target. A local body-coordinate frame may also be attributed to each of such elements. Typical examples of such elements are rigid bodies and skeleton bone segments. The motion capture trajectories 550 can then also describe the orientation and position of the local body frames—with respect to a global frame—attached to the elements as a function of time in addition to the positions of the marked points. In the simplest case, the motion capture trajectories 550, T(t), may be represented as:

$$T ( t ) = \{ {X}_{i} ( t ) \} ; i = 0 , ... , N - 1 \qquad ( Eq . 3 )$$

Where N is the total number of marked points (or markers being tracked); Xᵢ(t) is the 3D position vector with elements (x,y,z) describing the position of the ith marker as a function of time.

When some of the markers are grouped to form unit elements. Usually, to facilitate tracking by motion capture systems, a group may be stipulated to include a minimum number of markers (e.g. 3). However, for the purpose of this disclosure, a group or unit element may contain one or more markers. Then, T(t) may be defined as:

$$T ( t ) = \{ {P}_{j} ( t ) , {X}_{i} ( t ) \} ; j = 0 , ... S - 1 ; i = 0 , ... , N - 1 ; j \leq i \qquad ( Eq . 2 )$$

Where S is the total number of elements and each element includes a set of markers; Pⱼ(t) is the orientation or attitude of the jth element as a function of time.

Usually, a motion capture track file output from a motion capture system contains useful metadata in addition to the trajectories.

The motion capture trajectories 550 may be obtained from an optical motion capture system, a Kinect depth camera, computer animation of human performances, or AI agents emulating human activities in an environment such as 3D games or virtual reality environments. In optical or video motion capture systems, such as the gesture recognition and activity detection system 600 depicted in FIG. 6A, the marked points are usually distinguished by attaching some easily identifiable markers such as passive retro-reflective markers, active LEDs that may emit unique sequences of time-intensity patterns, or fiduciary markers, on the moving objects of interest. In some instances, sets of the identified marked points may be grouped together to represent a single shape. When the distances between the set of points representing a shape remain constant, the shape is called a rigid body. On the other hand, if the shape is allowed to deform bounded by some constraints, the distances between the set of points could vary. Parts of the human body may be modeled either as a set of rigid bodies or deformable shapes. Furthermore, when a motion capture system is used to record and represent biomechanical motions, a skeletal representation—composed of a hierarchical set of segments or bones—is usually reconstructed from the set of markers (points). The bones or segments in such skeletal models are connected at the bone vertices. When such representations are employed in this disclosure, the trajectories may represent the 3D positions of these vertices in addition to the 3D positions of the markers over time. Please note that the terminologies “object(s)” are “target(s)” are used interchangeably in this disclosure.

The synthesized electromagnetic (EM) scatter signals emulate the EM signatures of human activities (for example, Doppler and micro-Doppler signatures) as if a real EM signal transmission, reflection, and sensing had occurred. The synthesized and real EM sensing modality could be active or passive. In active EM sensing, one or more EM transmitter antennas are used to illuminate the environment for the purpose of sensing human activities. A portion of the transmitted EM signal is scattered after bouncing from various parts of the human body and sensed using one or more receiver antennas. The scattered EM signal sensed by the receiver antenna encodes a multitude of information about the human-in-the-environment such as the distance of the human (or other targets) from the EM receiver (derived from the delay between the transmitted and the reflected signal), the bulk motion or overall body movement, radial velocity (derived from the change in frequency of the received signal compared to the transmitted signal known as Doppler effect), and distinctive micro-motion patterns such as the distinctive patterns of hand movements during walking, (from the micro-Doppler signature). In some cases, the delay is not directly obtained but estimated from the phase of the received signal. Typical examples of active EM sensing employed for indoor activity human activity monitoring include millimeter-wave (mm-wave or mmWave) frequency-modulated continuous wave (FMCW) radar or pulsed radar such as Ultra-Wideband (UWB) radar. Passive sensing leverages the radio-frequency (RF) signals in an environment, for example, passive Wi-Fi radar (PWR) data may be collected in a Wi-Fi environment to compute the Doppler and micro-Doppler signature of human activity in the environment. Moreover, the myriad EM signal transmitters and receivers may have monostatic (transmitter and receiver are collocated) or bistatic (transmitter and receiver are separated) configurations. The exact radio technology and physical attributes used for activity sensing are mostly unimportant in the context of this disclosure as long as a suitable mathematical model for the particular EM modality of interest is available to accurately simulate the dynamic channel properties arising due to a set of moving point emitters/reflectors.

The motion capture trajectories 550 obtained from physical systems such as optical or video motion capture systems, Kinect sensors, may have noise. Additionally, there might be some gaps (i.e. missing data) in the tracking data for one or more markers for some time periods due to self-occlusions, inter-object occlusions, and other types of occlusions that may happen during the capture. Even trajectories obtained from computer animations may have some irregularities. In operation 504, a trajectory processing step interpolates missing data, if any, and, optionally, applies an appropriate filter to remove high-frequency noise from the trajectory time series. In an embodiment of this disclosure, an exponential moving average filter with a short span is used for processing the trajectories. Some trajectories may also have spike type of noise that, if not removed, may lead to the simulation of sudden unnatural movements. Therefore, the trajectory processing block may also include outlier detection and rejection filtering.

Depending upon the type of target application or human activity, a trajectory record or file may contain either a single activity, multiple activities, or multiple repetitions of the same activity. Additionally, there may be short periods of no activity or irrelevant activity before, after, or during the zero or more inter-activity periods in the trajectory records. Following the trajectory processing step, the beginning and ends of the activity of interest are identified and demarked in operation 506. When the entire file or record contains a single instance of an activity from an audio or video capture in operation 508 taken simultaneously as the motion capture of operation 502, then the start and end points may be implicit. That is, no start and end points are explicitly specified. The identification of the start and end points for operation 510 may be performed in several ways. In the simplest case, these points are manually identified and annotated. Alternatively, simple rules may be created to automatically determine the start and the end of the activity either by analyzing the motion tracks or the audio/video recordings, if available. As shown in FIG. 6A, one or more regular video cameras may be employed in the setup to simultaneously record video of the actions performed by a subject while the motion capture system captures the trajectories of the markers. Alternatively, some external sound may be played at the beginning and end of every activity instance. Later, the sound could be detected in the video or some other recording to identify the start and end points of the one-or-more activities. The timestamps of the start and end points may be stored as associated metadata either in a separate file or in the computer memory along with the tracks.

In operation 512, a data augmentation (DA) process is applied to the motion trajectories 550. For example, the DA process is one whose input is the motion trajectories 550 corresponding to an activity and the output is a plurality of sets of motion trajectories 552 with some variations representing variations of the activity. Data augmentation is used to artificially generate a large set of data, e.g., a set of data augmented motion trajectories 554, corresponding to physically plausible variations of the real data from a small set of real data, e.g., the motion capture trajectories 550, collected via measurements or experiments that are usually difficult to do or are time-consuming. The variations are usually random and the type of variations to be performed may be specified separately. Details on the type of data augmentation and how to implement a data augmentation pipeline to obtain an almost unlimited number of artificially generated variations of trajectories from a small set of real trajectories are explained in the later sections of this disclosure.

In operation 514, a time-varying radar cross-section (RCS) 156 is computed for every target in all sets of data augmented motion trajectories 554. The RCS of the target governs the amount of EM energy reflected back by the target. Resultantly, the RCS of the target governs the quality of target detection. For example, if the RCS of a target is large, it may be easily detected whereas if the RCS of the target is small, the target may be hard to detect. The RCS of a target generally depends on the frequency of the incident radiation, the polarization of the transmitting and receiving antennas, the orientation of the target relative to the antenna, also called the “aspect angle”, and the material and shape of the target. However, simulating the radar signatures of human activities, the important factor that determines the RCS as a function of time (represented as σ(t)) is the aspect angle of the target with respect to time (represented by θ(t) and ϕ(t)). Once the various point trajectories are available—both obtained directly from the motion capture system or synthetically generated via data augmentation—the RCS of the point emitters can be computed. The RCS computation of targets is generally application dependent. Details of how the RCS of the points may be computed are provided in later sections of this disclosure. The computed RCS, σ(t), for the set of points may be stored in a file or the memory of the computer.

The frame rate of the motion trajectories 550 and the frame rate of the radar signal (real or synthesized) could be different. For example, a frame rate of 120 Hz is typically used in optical motion capture systems. Whereas the frame rate of a mmWave FMCW radar depends on the number of chirps per frame, the number of samples per chirp, the chirp interval, and the sample rate. In some hardware, the radar's frame rate or frame interval (inverse of the frame rate) can also be specified directly in addition to the other parameters. Therefore, in operation 516, the set of data augmented motion trajectories 554 may be resampled to match the desired frame rate of the target radar. In an embodiment of this disclosure, the frame rate of the set of data augmented motion trajectories 554 is converted to match the target radar frame rate before the generating a set of EM scatter signals 558 in operation 518. Alternatively, the frame-rate conversion could be part of generating the set of EM scatter signals 558. Although the terms “EM scatter” and “EM backscatter” signals have slightly different connotations—while the former indicates scattering along any direction and is generally used in the context of bistatic transmitter-receiver configurations, the latter denotes the scattered energy received back at the receiver in monostatic configuration-they are used interchangeably in this disclosure.

Once an action of interest or a variation thereof, such as variations obtained using data augmentation, is available as a set of point trajectories, e.g., points and their 3D positions over a period of time, along with each point's RCS as a function of time, the backscattered EM signal can be simulated using an appropriate analytical model treating the set of point trajectories as point emitters of EM waves. That is, the entire moving object (or objects) is modeled as a set of point targets. Then, the resulting EM signal at a receiver antenna may be obtained as the phasor sum of the EM signals of each of the target point emitters. For example, in an embodiment of this disclosure, the baseband intermediate frequency (IF) signal for a mmWave monostatic FMCW radar with sawtooth linear frequency modulation is modeled as:

$${u}_{k , m} ( t , {t}^{′} ) = {\sum }_{i}^{N} {a}_{i} ( t ) cos ( 2 π ( \frac{2 {f}_{c} {r}_{i} ( t )}{c} + \frac{2 {Sr}_{i} ( t ) + 2 {f}_{c} {v}_{i}}{c} {t}^{′} ) ) \qquad ( Eq . 3 )$$

Where,

u_(k,m)(t,t′) is the beat signal or IF signal at the kth receiver antenna corresponding to the mth sweep of the linear modulation in the transmitted signal, obtained at the output of the mixer and following low-pass filtering and some approximation.

t′=t−mT_{c}, where T_{c} is the sweep duration, is the relative time from the beginning of the mth chirp.

N is the total number of point targets used to represent the entire moving object (or objects).

aᵢ(t) represents the reflected signal strength or amplitude including propagation loss, transmit power (Pₜ), transmitter and receiver antenna gains (Gₜ and Gᵣ), target radar RCS (σᵢ(t)), This amplitude may be expressed as aᵢ(t)=√((Pₜ Gₜ Gᵣ λ\hat{ }2σᵢ(t))/((4π)\hat{ }3 rᵢ\hat{ }4 (t))). Note that other losses such as system losses are included in the gain terms.

f_{c} is the carrier frequency. Also, it equal to the minimum sweep frequency fₘᵢₙ of the radar. Then, the bandwidth, B=fₘₐₓ−fₘᵢₙ, where fₘₐₓ is the maximum frequency, and S is the slope, given as S=B/T_{c}.

rᵢ(t) is the distance of the ith point target from the radar as a function of time.

vᵢ is the radial velocity of the ith point target. It is assumed to be vᵢ is sufficiently slow so that the range rᵢ remains constant during a sweep.

c is the velocity of light (or EM wave).

The term ϕₒ=4πf_{c} rᵢ/c or ϕₒ=4πrᵢ/λ is the initial phase of the IF signal. The phase, ϕₒ, changes linearly for small changes in rᵢ.

The term f_{b}=2Srᵢ (t)/c is the instantaneous frequency of the IF signal (also called the beat frequency) related to the ith point target.

The term f_{d}=2f_{c} vᵢ/c is the Doppler frequency related to the ith point target.

The expression in Eq. 3 was obtained by representing the transmitted signal as a sinusoidal signal with a linearly changing frequency:

$${u}_{TX} ( t ) = {a}_{T} cos ( 2 π {f}_{c} t + π {S ( t - {mT}_{c} )}^{2} ) \qquad ( Eq . 4 )$$

Then, the backscattered signal for the mth sweep at a receiver antenna k can be represented as the summation of the delayed and attenuated version of the transmitted signals reflected from all the point targets as shown in Eq. 5:

$${u}_{RX - k} ( t ) = {\sum }_{i}^{N} {a}_{RX , i} ( t ) cos ( 2 π {f}_{c} ( t - {τ}_{i} ) + π {S ( t - {τ}_{i} - {mT}_{c} )}^{2} ) \qquad ( Eq . 5 )$$

Where, τᵢ=2(rᵢ+vᵢt)/c is the round-trip delay associated with the ith target moving with radial velocity vᵢ at a distance rᵢ from the radar.

The signal u_{TX}(t) u_{(RX-k)}(t) obtained by mixing the transmitted and the received signals is low-pass filtered to obtain the beat signal. Following some simplification and removal of insignificant terms under certain assumptions, such as sufficiently short sweep durations, ignoring terms having c² in the denominator, the expression in Eq. 3 is obtained.

To account for more realistic scenarios noise terms may be added to Eq. 3 that account for random system noise and the contribution of antenna leakage bias (the direct leakage of power from the transmitting antenna to the receiving antenna) in monostatic configurations. While the random system noise may be modeled as Gaussian noise, the antenna leakage bias is usually a constant value. Therefore, Eq. 4 may be used to simulate more realistic scenarios:

$${u}_{k , m} ( t , {t}^{′} ) = {\sum }_{i}^{N} {a}_{i} ( t ) cos ( 2 π ( \frac{2 {f}_{c} {r}_{i} ( t )}{c} + \frac{2 {Sr}_{i} ( t ) + 2 {f}_{c} {v}_{i}}{c} {t}^{′} ) ) + 𝒩 ( t ) + b \qquad ( Eq . 4 )$$

Where,

N (t) accounts for random system noise.

b accounts for constant biases such as antenna leakage bias in monostatic configurations.

In another embodiment of this disclosure, as required by the target application employing UWB radar, a pulsed radar-based analytical model may be used to synthesize the EM scatter signals from a set of point trajectories.

FIG. 6A illustrates the gesture recognition and activity detection system 600 used to synthesize a large set of EM signatures of human gestures using data augmentation. Several retro-reflective markers 602 may be attached to the different parts of a target 604, e.g., a body of a subject, as shown in FIG. 6A. As the target 604 enacts different gestures or activities, several motion capture cameras 606 synchronously capture the 2D videos of the performance from various angles around the target 604. The 3D positions of each of the markers 602 are then reconstructed using the motion capture software from the 2D videos and camera calibration data using triangulation. A sequential collection of the 3D positions sampled over time forms a trajectory of a marker 602. The enactment of an activity or gesture produces a set of trajectories 550 corresponding to all the markers 602 attached to the target 604. To improve the accuracy of marker localization and prevent stray reflections from interfering with the 3D reconstruction, infrared (IR) cameras 608 are usually employed. IR LED illuminators are also used to illumine the scene. The retro-reflector markers 602 reflect light most strongly at the IR wavelength matching the operating IR wavelength of the motion capture cameras 606. IR LEDs may also be used in place of retro-reflector markers. Furthermore, in an embodiment of this disclosure, a regular (operating in the visible wavelength spectrum) video camera is used to synchronously capture the performance as shown in FIG. 6A. The video from this camera is used as an additional input to the system to determine the start and end times of the gesture or activity of interest when more than one activity or gesture is performed during a continuous capture.

In an embodiment of this disclosure, the target 604, e.g., human body parts such as the hand (or palm), the forearm, the upper arm, and the torso, are modeled as planar rigid bodies (RB) as shown in FIG. 6B. For example, a palm rigid body 610 includes markers 602 numbered 1-5, a forearm rigid body 612 includes markers 602 numbered 6-9, and the upper arm rigid body 614 includes markers 602 numbered 10-15. Although not shown in the figure, the torso may also be modeled as a rigid body using of a set of markers 602. Since each part of the body is modeled as rigid bodies, the group of markers 602 belonging to a particular rigid body is constrained to remain in fixed positions with respect to each other.

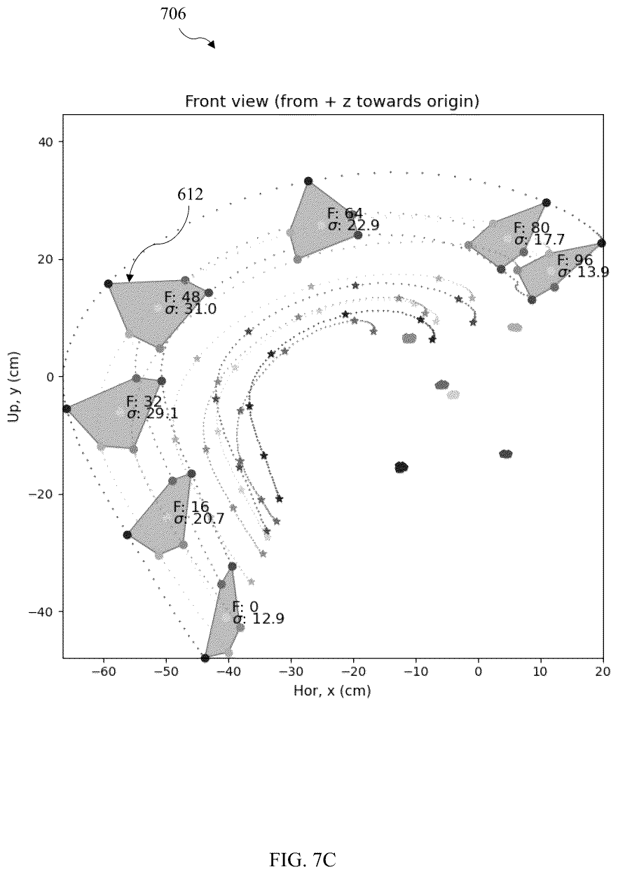

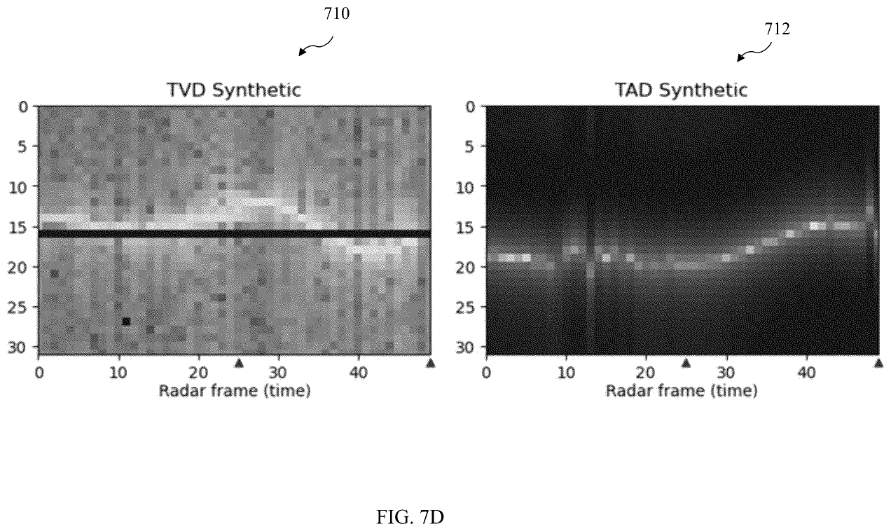

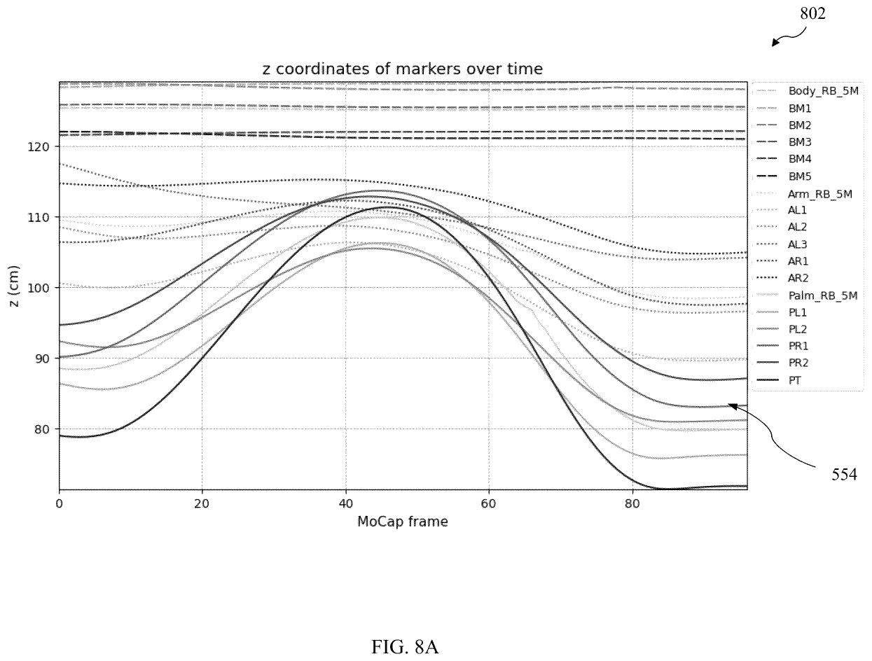

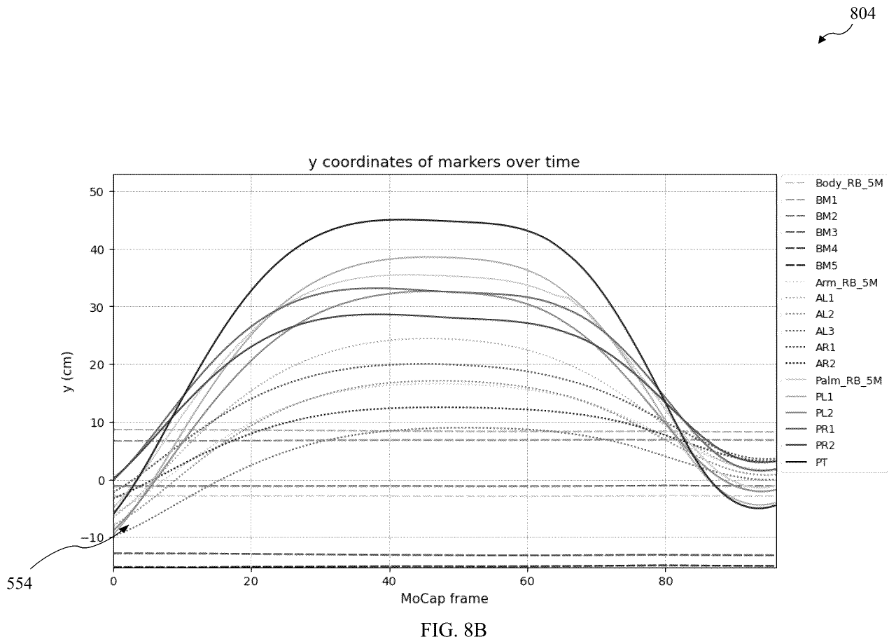

FIG. 7A through FIG. 7D illustrate motion capture trajectories 550, 554 of a swipe left to right and the corresponding radar signature features which may be captured and generated by the gesture recognition and activity detection system 600. FIG. 7A illustrates an example of depth coordinates of a target rigid body marker trajectories for a left to right swipe gesture according to various embodiments of the present disclosure. FIG. 7B illustrates an example of height coordinates of the rigid body marker trajectories for a left to right swipe gesture according to various embodiments of the present disclosure. FIG. 7C illustrates an example of planar coordinates of rigid body markers over time along with the polygons of the target rigid body and radar cross-section for a left to right swipe gesture according to various embodiments of the present disclosure. FIG. 7D illustrates an example of features computed from synthetic EM scatter signals for a left to right swipe gesture according to various embodiments of the present disclosure.

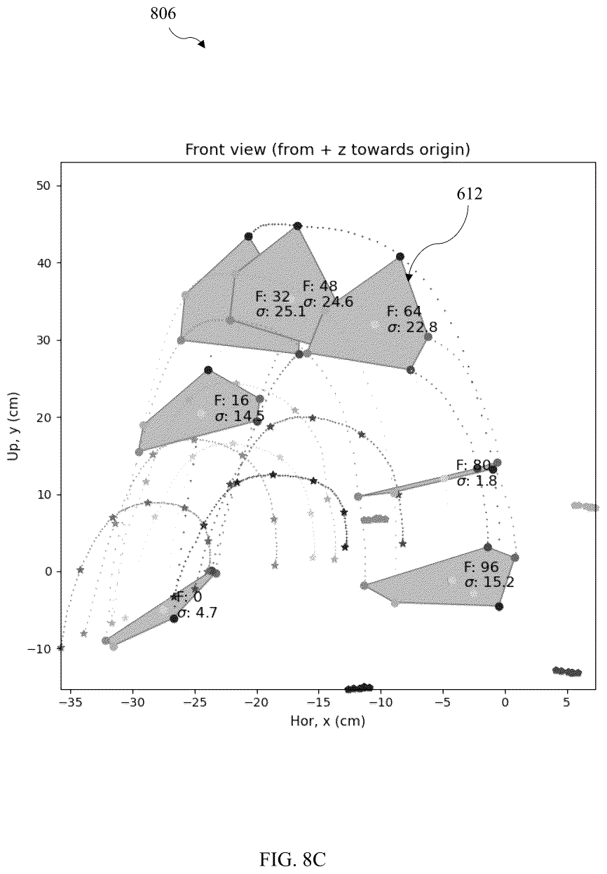

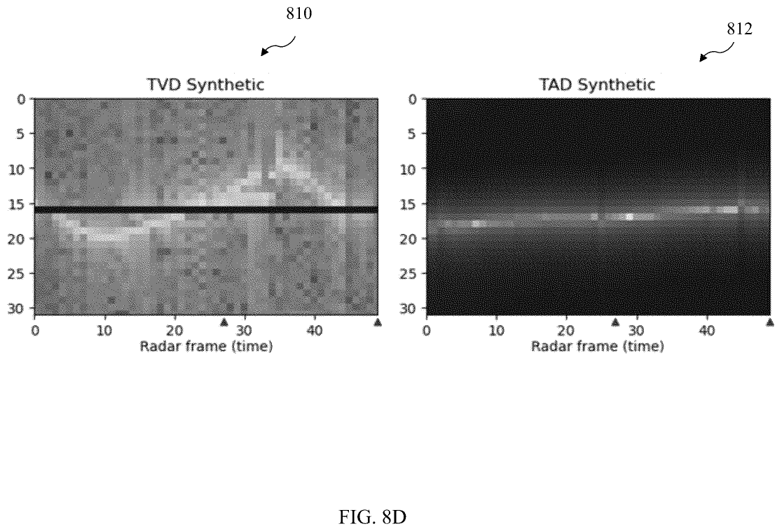

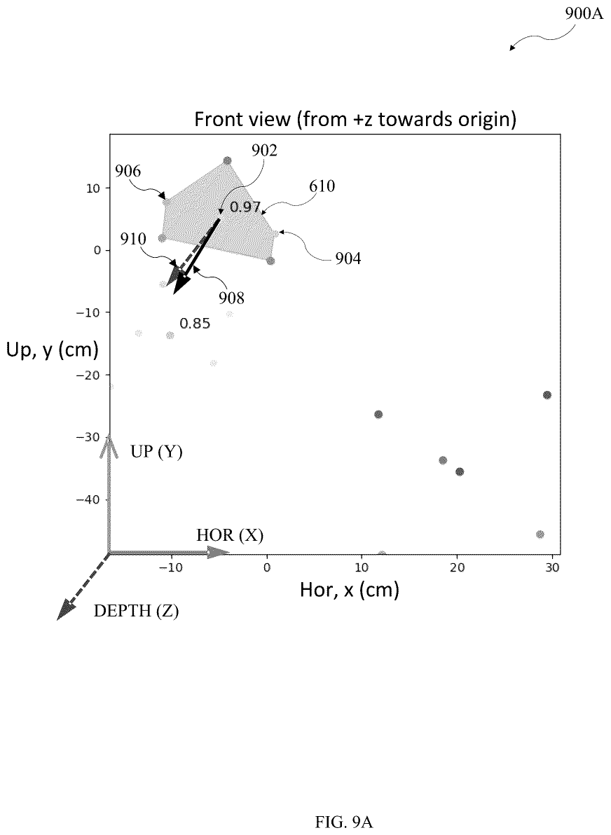

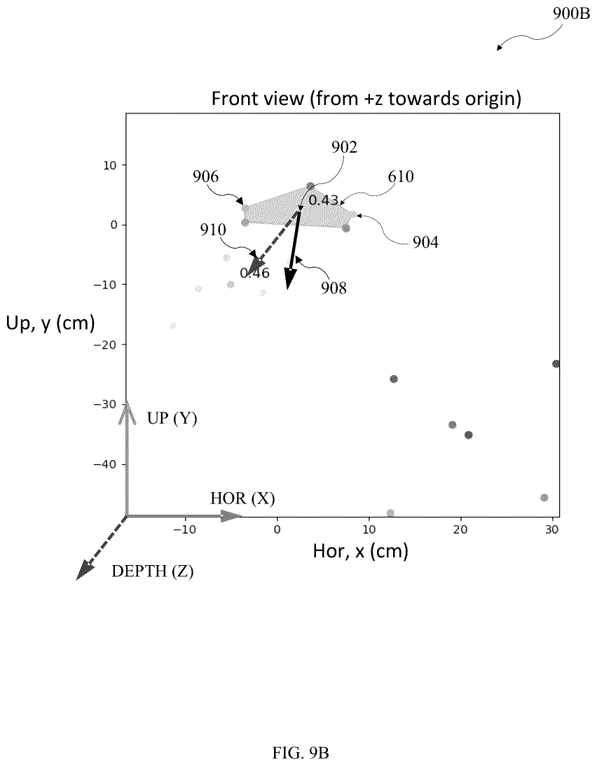

Similarly, FIG. 8A through FIG. 8D illustrate motion capture trajectories 550, 554 of a tap gesture and the corresponding radar signature features that may be used to classify the gestures in a gesture recognition application which may be captured and generated by the gesture recognition and activity detection system 600. FIG. 8A illustrates an example of depth coordinates of a target rigid body marker trajectories for a tap gesture according to various embodiments of the present disclosure. FIG. 8B illustrates an example of height coordinates of the rigid body marker trajectories for a tap gesture according to various embodiments of the present disclosure. FIG. 8C illustrates an example of planar coordinates of rigid body markers over time along with the polygons of the target rigid body and radar cross-section for a tap gesture according to various embodiments of the present disclosure. FIG. 8D illustrates an example of features computed from synthetic EM scatter signals for a tap gesture according to various embodiments of the present disclosure.

Specifically, FIG. 7A and FIG. 8A show z-coordinates in trajectory graphs 302, 402 of the motion capture trajectories 550 of the rigid body markers 602 of the palm rigid body 610, forearm rigid body 612, and torso of the target 604 for the swipe left to right (FIG. 7A) and tap gestures (FIG. 8A). The z-axis in the trajectory graphs 302, 402 represents the depth or distance of the markers 602 from a radar receiver. For example, FIG. 7A indicates that the target 604, e.g., a subject body, was about 125 cm from the radar while performing the gesture based on the markers 602 “BodyᵣB_5M”, “BM1”, “BM2”, “BM3”, “BM4”, and “BM5” that were attached to the torso of the target 604. Furthermore, the trajectory graph 302 indicates that the target 604 arches forward towards the radar between 20-25 cm during the gesture based on the markers 602 “PalmᵣB_5M”, “PL1”, “PL2”, “PR1”, “PR2”, and “PT” that were attached to the target 604, e.g., a subject palm. In this case, the swipe left to right gesture doesn't start at frame 0, but rather around frame 45 based on the definition of the gesture in the particular application. The portion between frame 0 and frame 45 constitutes the pre-gesture action. Similarly, FIG. 8A indicates that the target 604 was about 125 cm from the radar while performing the tap gesture and the palm/hand moves forward towards the radar and rests in that position for a short duration at the end of the gesture.

The frames in FIGS. 3A, 3B, and 3C, and FIGS. 4A, 4B, and 4C are indicated as motion capture frames while the frames in FIG. 7D and FIG. 8D are radar frames. The motion capture frames are radar frames are related by the relative frame rates of the motion capture system and the radar system. For the examples, while the motion capture frame rate was 120 Hz, the radar system frame rate was 61.9 Hz. Therefore, frame number 50 in motion capture frames corresponds to approximately frame 26 in radar frames.

FIG. 7B and FIG. 8B depict the y-coordinates trajectory graphs 304, 404 of the motion capture trajectories 550 of the rigid body markers 602 of the palm rigid body 610, forearm rigid body 612, and torso of the target 604 for the swipe left to right gesture (FIG. 7B) and tap gesture (FIG. 8B). The y-axis in these figures represents the height of the markers 602 with respect to the radar receiver which is set at the origin of the coordinate frame. FIG. 7B shows that the target 604, e.g., the arm of the user, moves up by about 40 cm at the highest point of the gesture action. Similarly, FIG. 8B indicates that the target 604, e.g., the arm of the user, moves from high to low during the gesture action (note the arm initially rising up during the pre-gesture period of 0-45 frames).

FIG. 7C and FIG. 8C show planar (x, y) coordinates in planar trajectory graphs 306, 406 of the markers 602 during the respective gesture actions. Polygons representing the palm rigid body 610 and its markers 602 at times Oms (frame 0), 133 ms (frame 16), 267 ms (frame 32), 400 ms (frame 48), 533 ms (frame 64), 667 ms (frame 80), and 800 ms (frame 96) are shown to illustrate the palm rigid body 610 from the viewpoint of an observer behind the user and looking towards the radar. The RCS 556 at these time instances is also shown. The RCS for the rigid bodies may be computed as the area of the shape of the rigid body projected on the X-Y plane, referred to as the projected area. The RCS 556 of the palm rigid body 610, depicted by the pentagons, is large when the elevation angle θ, defined as the angle of the rigid body plane from the vertical axis, and the azimuth angle ϕ, defined as the angle of the rigid body plane normal with respect to the line joining the rigid body center and the radar along the horizontal plane, is close to zero. In other words, the RCS is maximum when the rigid body is fronto-parallel (head-on) to the radar.

FIG. 7D shows the synthetic time-velocity diagram (TVD) 710 and the synthetic time-angle diagram (TAD) 712 calculated from the radar signal, e.g., the beat signal, for the left-to-right swipe gesture. Similarly, FIG. 8D shows the synthetic TVD 810 and the synthetic TAD 812 computed from the radar signal (beat signal) simulated using Eq. (4). The virtual mmWave frequency-modulated continuous wave radar system, incorporated frame-based radar processing, includes one transmitter and three receiver antennas and operating between 58 GHz and 6 GHz with a bandwidth of 3 GHz.

To generate a TVD and TAD, such as the synthetic TVD 710, the synthetic TVD 810, the synthetic TAD 712, and the synthetic TAD 812, requires radar frames. The radar frame in the example includes Nc chirps, such as 32 chirps, with Ns samples per chirp, such as 64 samples per chirp. The simulated radar signal, obtained at each of the virtual receiver antennas, includes Nc×Ns×NF where NF is the number of radar frames. For each radar frame, a Range Density Map (RDM) is computed by first taking Fast Fourier transforms (FFTs) along each row of Ns samples (called range FFT), discarding the first Ns/2 symmetric values, and then computing FFTs along each column (called Doppler FFT) resulting in Nc×Ns/2 RDM for each frame. The values in the zero-Doppler bin are nulled to remove the static contribution from the direct leakage (as it may be added to the simulated signal in Eq. (4) to match realistic scenarios). A rand profile is obtained from the RDM by summing the power across all Doppler bins (i.e. summing along each column of the RDM). Peaks in the range profile are detected after comparing the range plot against a detection threshold. The first detected peak in the range plot corresponds to the location of the hand (assuming the hand is the closest object to the radar during the gesture action). The column in the RDM corresponding to the detected peak in the range plot is picked to construct a column of the TVD. Repeating the above process for the NF radar frames results in Nc×NF-sized TVD. The simulated radar signal at any one of the receiver antennas may be used to generate the TVD. Alternatively, the mitigate the effect of noise, the radar signals from the three receiver antennas may be averaged. A column of TAD is obtained by picking the columns corresponding to the first peak used for TVD from the range FFTs obtained from two neighboring receiver antennas, constructing a covariance matrix, and applying the MUSIC algorithm to obtain the angular spectrum.

The strength of the radar signature at the receiver as shown in Eq. (4) is:

$${a}_{i} ( t ) = \sqrt{\frac{{P}_{t} {G}_{t} {G}_{r} {λ}^{2} {σ}_{i} ( t )}{{( 4 π )}^{3} {r}_{i}^{4} ( t )}}$$

where, σᵢ(t) is the RCS (radar cross-section) of the ith target 604.

As indicated earlier, an RCS 556 of the target 604 is one of the crucial factors determining whether it can be detected by a radar system since its RCS 556 determines the amount of energy reflected by the target 604 towards the radar. Furthermore, for tasks like human gesture and activity detection and classification using EM signatures, the time-varying RCS from different targets 204, e.g., different parts of the body-in-motion, results in distinctive features that are essential for machine learning (ML) based automated gesture and activity classification. Therefore, modeling the RCS is an important consideration for these systems. At the same time, for task-specific applications such as human activity and gesture recognition in relatively predictable environments, it may be sufficient to model the RCS of the different parts of the human body as planar rigid bodies or primitive shapes, such as ellipsoids, and only account the relative RCS between the different parts as a function of time. In other words, the factors such as the polarization of the transmitted and received radiation with respect to the target 604 orientation, material properties of the target 604, may be ignored.

Note that the definition of the term “target” includes but is not limited to the 3D points corresponding to actual markers estimated by physical markers utilizing real cameras, computer animation, 3D games, or AI-based, such as from 2D videos to 3D, motion capture system, virtual points derived from the actual markers, such as centroids of rigid bodies, the origin of bone segments in skeleton tracking, or shapes used to model parts or whole of the human body in primitive-based modeling.

In an embodiment of this disclosure targeting the task of hand gesture recognition, parts of the human hand and body are modeled as planar rigid bodies as shown in FIG. 6B. Physically, retro-reflective markers 602 may be fixed on pieces of rigid planar boards that may be attached to the palm/hand, forearm, upper arm, and body. The size and shape of the planar boards should ideally correspond to the associated body part. During the activity or gesture, the planar boards with the markers 602 follow the motion of the different parts of the body as they are attached to the body parts (using, for example, Velcro tapes). Then, the time-varying RCS 556 for each rigid body is computed.

To compute a time-varying RCS 556 for targets 204 modeled as a set of planar rigid bodies, e.g., palm rigid body 610, is as follows and is illustrated using FIGS. 5A, 5B, 5C, and 5D. For each rigid body, e.g., palm rigid body 610, in each motion capture frame, e.g., first motion capture frame 500A, second motion capture frame 500B, third motion capture frame 500C, and fourth motion capture frame 500D, a centroid 502 of the palm rigid body 610 is determined as an average of the positions of all the markers 602 of the palm rigid body 610. Once, the centroid 502 is determined, position vectors of two markers 602 are determined, e.g., a first position vector 504 and a second position vector 506, such that centroid 502, first position vector 504, second position vector 506 are non-collinear. Then, vectors joining the centroid 502 and the first position vector 504, e.g., a first joining vector, and the centroid 502 and the second position vector 506, e.g., a second joining vector, are determined. Once the first joining vector and the second joining vector are determined, a unit normal vector 508 is generated as the normalized cross product of the first joining vector and the second joining vector. Thereafter, to determine a projected angle of the at least one planar target with respect to a radar axis, e.g., the unit normal vector 508, of a virtual radar direction, the inner product of unit normal vector 508 and a centroid unit vector 510 along the centroid 502. Once this is determined, the RCS 556 of the palm rigid body 610 may be determined as:

$$σ ( t ) = \vert r ( t ) W \vert$$

where W is the absolute area/size of the rigid body, e.g., the palm rigid body 610.

In the above procedure for calculating the RCS, the centroid unit vector 510 is a unit vector along the line joining the centroid of the rigid body and the radar. For some task-specific applications where the total movements of the target 604 are expected to be bounded within a small angular region in front of the radar, such as hand gesture recognition to control a TV or other such appliances, centroid unit vector 510 could simply be the unit direction vector along the depth assuming the virtual radar is positioned at the origin of the coordinate system. This approximation further simplifies the computation of the time-varying RCS 556.

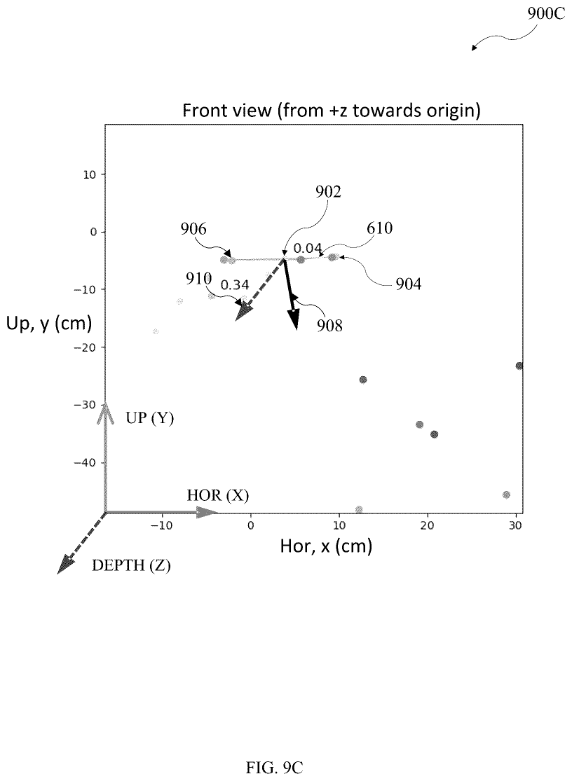

FIGS. 9A, 9B, 9C, and 9D illustrate examples of a time-varying radar cross-section for a planar rigid body at different orientations according to various embodiments of the present disclosure which may be captured and determined by the gesture recognition and activity detection system 600. The RCS 556 computed using the above procedure for the palm rigid body at certain positions is shown in FIGS. 5A through 5D. The area of the palm is assumed to be unity to highlight the RCS value at each of these orientations. So, the maximum possible RCS 556 value is equal to one (1). In FIG. 9A, the orientation of the palm rigid body 610 is almost fronto-parallel to the radar resulting in an RCS 556 value of 0.97 in the first motion capture frame 500A. At this position, the reflected energy from the palm rigid body 610 is almost at its highest. The RCS 556 value decreases as shown in the second motion capture frame 500B of FIG. 9B owing to a tilt of the palm rigid body 610 towards the forward direction. The RCS 556 is close to zero (0.04) in the third motion capture frame 500C, reflecting minimal energy when the palm rigid body 610 is facing down in FIG. 9C. Finally, as shown in the fourth motion capture frame 500D of FIG. 9D, the palm rigid body 610 is rotated causing a smaller projected area and lower RCS 556.

The RCS 556 of each point target 604 is then obtained by dividing the RCS 556 of the rigid body, e.g., the palm rigid body 610, by the number of markers 602 used to represent the palm rigid body 610. Similarly, when primitive shapes such as ellipsoids are used to model body parts, the RCS 556 of the points may be obtained by dividing the RCS 556 of the primitive shape by the number of points used to represent the primitive shape while computing the EM signature using an analytical model like Eq. 4.

While the above method for RCS computation of body parts modeled as rigid bodies is simple and fast which is suitable for lower power embedded AI systems at the edge, it does not consider the effects of self-occlusion of parts of the body during the course of an activity. This limitation is not inhibitory for synthesizing Doppler and micro-Doppler signatures of human gesture recognition and simple activity detection such as fall detection, running and walking detection. However, for more complex activities such as for exercise classification RCS computation may consider the effects of self-occlusions.

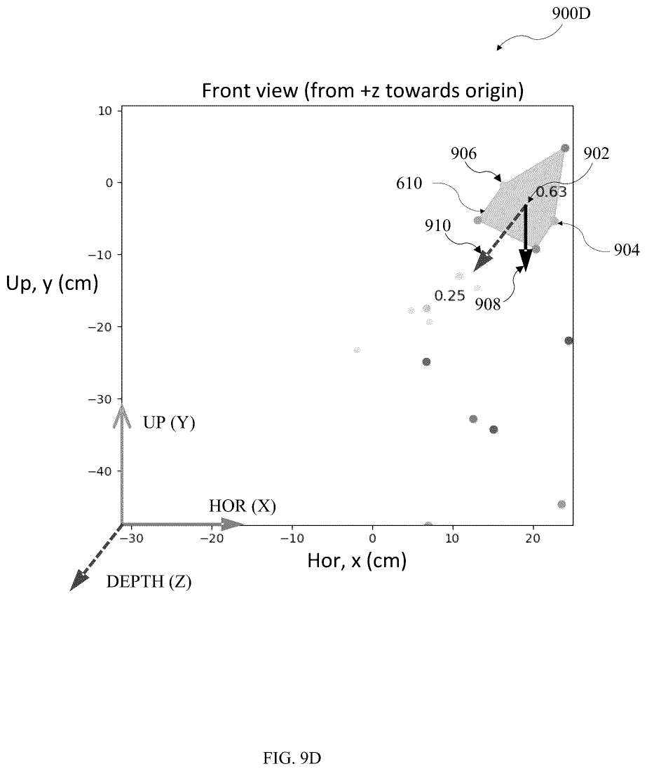

FIG. 10 illustrates an example of a flowchart showing the method 1000 which may be executed using the processor 224 of an electronic device, such as the gesture recognition and activity detection system 600, to perform data augmentation on segments of motion capture trajectories 550, 554, generate time-varying RCS of the targets 604, and synthesize the set of EM scatter signals 558 encoding the signatures of human activities. In an embodiment of this disclosure, one or more separate files, such as configuration and settings file 1050, are used to provide various settings and configuration data. Example of such data could include but is not limited to motion capture and subject radar framerates, gesture start and end information, object modeling information used for RCS calculation, such as the type of model, e.g., a rigid body, skeleton, ellipsoidal primitives, and the absolute areas, sizes, dimensions, or other parameters that control the size of the primitives, whether to generate a fixed number of radar frames if the simulated radar uses frame-based radar processing, padding information if a fixed number of frames are generated, and specifications for doing data augmentation.

After getting the initial motion capture trajectories 550 and radar position information in operation 1002, a secondary modality such as video, audio, or even manual inputs may be used to mark the start and end of gesture/activity actions at operation 1004. Such information is especially useful when motion capture data for multiple instances of gesture/activity are recorded in the same file. The system processes this information and converts the start and end points to the motion capture frame (or time) domain to extract and process the segments separately in operation 1006. The system may also get the virtual radar position from the settings and configuration file if specified. Alternatively, the radar position may be indicated using markers 602 in the scene during motion capture. Following smoothing and filling missing data in the trajectories using appropriate interpolation techniques, such as spline interpolation, in operation 1008, a coordinate transformation is applied to trajectories to set the position of the radar as the origin of the coordinate system in operation 1010. If the radar location is fixed, this operation could be as simple as subtracting the radar position from the position of all the markers 602 over all time.

In operation 1012, as shown in the flowchart in FIG. 10, a pool of data augmentation (DA) functions is created to generate multiple new sets of data augmented motion trajectories 554 by transforming the plurality of sets of motion trajectories 552 in the captured data in operation 1014. The process for generating the pool of DA functions in an embodiment of this disclosure is explained in reference to FIGS. 9A and 9B. Once the pool of DA functions is available, a looping mechanism is used to loop through each DA function to generate a new trajectory for the set of data augmented motion trajectories 554 by the application of the DA function, generate the time-varying RCS 556 for every element, and synthesize the appropriate number of frames for the set of EM scatter signals 558 using an analytical model.

As indicated in FIG. 10, some DA functions, especially those that modify the spatial aspects of trajectories, apply the transformations only between the start and end locations of the plurality of sets of motion trajectories 552 when the trajectory segment, T_{g}(t), contains more data than the actual gesture action such as pre- and post-gesture actions. Applying spatial transformation to the trajectory portions beyond the actual gesture action may result in unwanted distortions to the trajectories that may corrupt the simulated EM signature of the action.

A function of data augmentation (DA) is to synthesize a larger set of new data from a smaller set of actual or measured data by applying modifications or transformations to the original data. The larger the size of the set of synthesized data compared to the size of the original data, the greater the benefit of DA. Ideally, the larger set of augmented data should contain different variations in the possible actions that are not present in the original data set either difficulty or time constraints or because the size of the original dataset is small.

In an embodiment of this disclosure, a variety of data augmentation techniques are used to transform the activity trajectories, such as spatial DA transformations, temporal DA transformations, and background noise DA transformations.

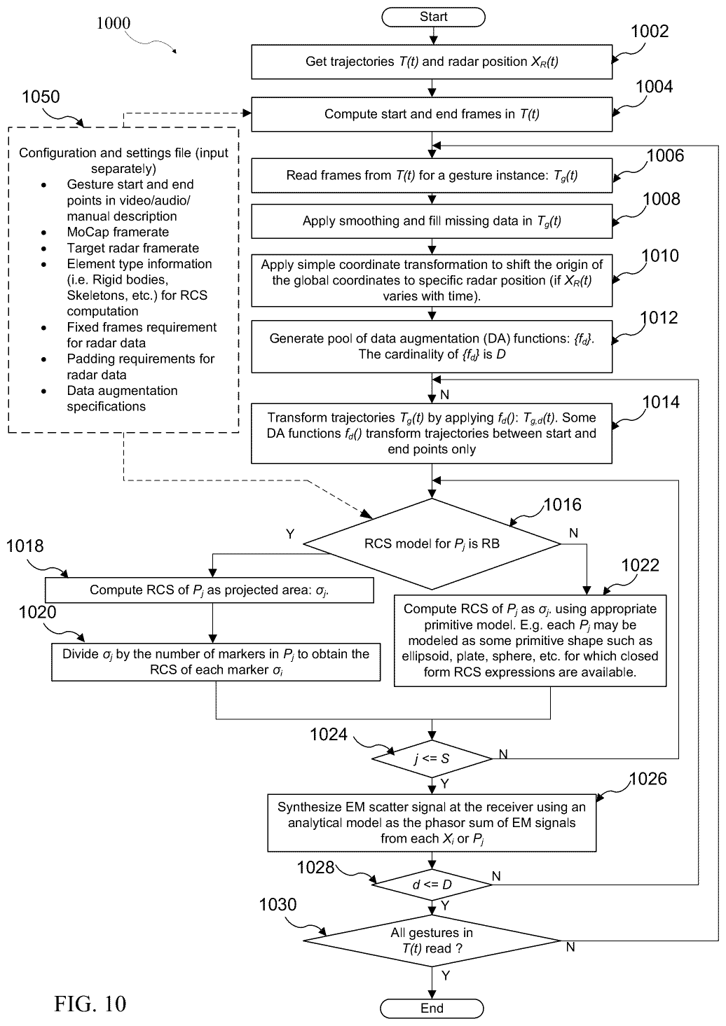

FIGS. 11A, 11B, 11C, 11D, and 11E illustrate an example of data augmentation transforms on motion capture trajectories according to various embodiments of the present disclosure which may be performed by the gesture recognition and activity detection system 600. An example of a spatial DA transformation may include a transformation to spatially vary the arm, including palm, forearm, and upper arm, and body marker trajectories along the Y-axis relative to the radar simulating the variation of radar receiver height with respect to the user. This transformation can be achieved by adding a randomly generated constant displacement value to the y-coordinates of all the trajectories for all time samples, e.g., motion capture frames, in the gesture segment. The displacement can be either positive or negative corresponding to up or down directions. A trajectory displacement graph 700A is shown in FIG. 11A which illustrates a positive displacement of the original trajectory 550 to a higher position along the Y-axis of the data augmented motion trajectory 554.

Another example of one such spatial DA transformation may include a transformation to spatially vary the arm and body marker trajectories along the X-axis relative to the radar simulating the variation of the radar location (left or right) with respect to the user. This transformation can be achieved by adding a randomly generated constant displacement value to the x-coordinates of all the trajectories for all time samples (motion capture frames) in the gesture segment. Here too, the displacement can be either positive or negative corresponding to the left or right directions.

Yet another example of one such spatial DA transformation may include a transformation to vary the arm and body marker trajectories along the Z-axis relative to the radar to simulate the variation of the depth of the radar from the user. Similar to a. and b., the transformation can be realized by adding a randomly generated constant displacement value—either positive (away from the radar) or negative (towards the radar)—to the z-coordinates of all the trajectories for all time samples in the gesture segment. A trajectory displacement graph 700A is shown in FIG. 11A which illustrates a positive displacement of the original trajectory 550 to a higher position along the Y-axis of the data augmented motion trajectory 554.

A further example of a spatial DA transformation may include a transformation to vary only the arm marker trajectories along the Z-axis relative to the centroid of the body marker trajectories to vary the spatial separation between the arm and the body. However, the randomly generated constant displacement term is only added to trajectories of the palm rigid body 610, the forearm rigid body 614, and the upper arm rigid body 614 trajectories but not to the body marker trajectories.

Additionally, a spatial DA transformation may include a transformation to vary the angle of incidence or the aspect angle of the target 604, e.g., an arm and body, markers 602 relative to the radar to simulate the variation of the angular position of the radar with respect to the user. One way to realize this transformation is to vary the position of the virtual radar along an arc around a point defined by the centroid of the body markers 602. The angle of incidence and self-occlusions are automatically handled during the RCS computation. Alternatively, a 3D rotation transformation matrix may be multiplied to all the trajectories, which are 3D position vectors as a function of time, of all markers 602 for all instances of time, e.g., for each of the motion capture frames, rotate the trajectories about the Z-axis. This assumes that the virtual radar is located at the origin of the global coordinate system.

A DA transformation may include a transformation to vary the curvature of the arm marker trajectories along the Y-axis while keeping the body marker trajectories unchanged to simulate the plausible variations of the arc of a gesture action along the vertical axis. A trajectory transformation graph 700B is shown in FIG. 11B which illustrates a curvature transformation of the original trajectory 550 along the Y-axis to the curvature of the data augmented motion trajectory 554.

Another DA transformation may include a transformation to vary the curvature of the arm marker trajectories along the Z-axis while keeping the body marker trajectories unchanged to simulate the plausible variations of the arc of a gesture action along the depth axis. A trajectory transformation graph 700B is shown in FIG. 11B which illustrates a curvature transformation of the original trajectory 550 along the Z-axis to the curvature of the data augmented motion trajectory 554.

A DA transformation may also include a transformation to stretch or compress the spatial extent of the gestures along the X-axis to simulate the variations of the gesture extents. The transformation is applied to the arm markers 602 only. This transformation may be realized by scaling the x-coordinates of the arm trajectories. A trajectory transformation graph 700C is shown in FIG. 11C which illustrates a compression transformation of the original trajectory 550 along the X-axis to the spatial extent of the data augmented motion trajectory 554.

An example of a temporal DA transformation may include a transformation to linearly vary the speed (faster or slower) of the gesture or action to simulate the variance in speed of gesture actions by different users or even by the same user. This transformation can be achieved by up-sampling and down-sampling the spatial coordinates of the trajectories by different factors to affect a speed change. A trajectory transformation graph 700D is shown in FIG. 11D which illustrates a linear speed transformation of the original trajectory 550, e.g., compression of the trajectory along the time axis, to the data augmented motion trajectory 554.

Another example of a temporal DA transformation may include a transformation to non-linearly vary the speed of the gesture or action.

Yet another example of a temporal DA transformation may include a transformation to shift the temporal occurrence (delay or advance the start) of the gesture or action. This transformation can be achieved by advancing or decreasing the start point of the gesture in the segment. Such operation requires “padding” data either to the beginning or towards the end of the original gesture segment. The padding can be achieved by repeating the nearest (first or last) trajectory positions. A trajectory transformation graph 700E is shown in FIG. 11E which illustrates a temporal delay transformation of the original trajectory 550, e.g., shifting the start of the gesture further along the time axis, to the data augmented motion trajectory 554.

A background noise DA transformation, different from the type of random noise introduced in Eq. 4, may include a transformation, e.g., addition, of extra trajectories to represent other objects or unwanted actions surrounding the target 604 action. Additionally, useful temporal DA transformations may include transformations to generate non-gesture actions to simulate random actions by users in front of the radar system that should not be classified as a specific gesture in the defined gesture vocabulary. Such data can also be used in ML training to improve the performance of the classifier.

Note that the DA transformations affect the time-varying RCS 556, radial velocity, and range of the different targets 604 involved in the action thereby producing slightly different signatures within the same class of action.

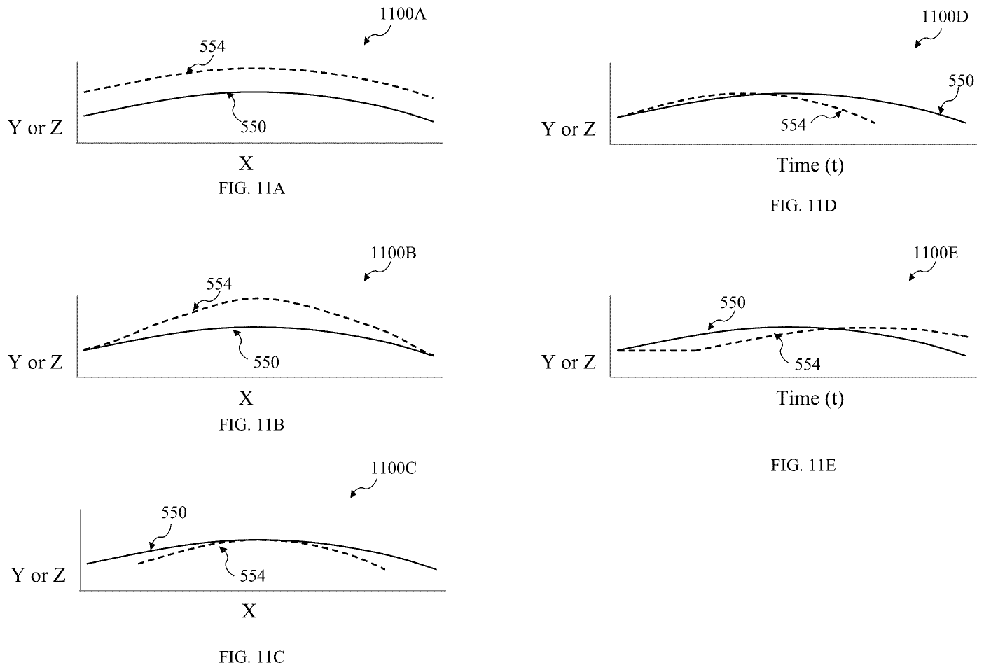

FIG. 12 illustrates an example of a varying trajectory curvature using fourth order Bezier curve interpolation according to various embodiments of the present disclosure which may be performed by the gesture recognition and activity detection system 600. In an embodiment of this disclosure, the curvature of the trajectories, e.g., the plurality of sets of motion trajectories 552, can be changed by using forth order Bezier curve interpolation as shown in the trajectory curvature graph 1200 of FIG. 12. First, the trajectory corresponding to the centroid of all the arm markers 602 is chosen or generated. Then, a number of control points 1202 are assigned. For example, five control points 1202 may be assigned as follows: point 1210 and point 1218 correspond to the start and end of the gesture's centroid trajectory. The x-coordinate of the point 1214 correspond to the x-coordinate of the point having the maximum height in the original centroid trajectory. The height 1214A of the point 1214 is randomly generated. The x-coordinates of point 1212 and point 1216 are weighted averages of the x-coordinates of the points 1210 and 1214, and 1214 and 1218. The height of the points 1212 and 1216 are assigned some random fractions of the height of the point 1214. Then, a fourth-order Bezier curve 1204 is constructed using the control points. The final, data augmented motion trajectory 554 is obtained by a weighted average (and interpolation) of the Bezier curve and the original trajectory. Greater weights are assigned to the original trajectory towards the beginning and end, while towards a maximum Y point, the Bezier curve gets greater weight. The transformed centroid trajectory is then used to transform all the other trajectories.

In an embodiment of this disclosure, each of the above transformation is implemented by a separate DA function. All DA functions have the same function call and return signature. In other words, all DA functions accept the same set of parameters which include at least a trajectory and the start and end locations of the activity (additional, application-dependent parameters may also be included) and return the same parameters. The exact means of passing the arguments to the functions and obtaining returns from the DA functions is programing language and implementation specific. For example, while in some programming languages like C/C++, it may be more conducive to pass the arguments by reference and do in-place computations that store the results in the same memory location, in other programming languages such as Python, it may be to pass the arguments as value and return the same type of arguments so that they can be readily passed to the chained function in the sequence. Unifying the interface of the DA functions allows the DA pipeline to create a large set of transformations using a combination of a smaller set of composable (or chainable) functions.

Further, in an embodiment of this disclosure, the parameters controlling the various transformations in each DA function are varied randomly at runtime. Therefore, applying the same DA function or the same combination (sequence) of DA functions subsequently produces slightly different transformations of the same type to the original trajectory. Thus, using the above strategy of composable or chainable DA functions and generation of the random control parameter values within each DA function enables an almost infinite number of possible transformations and corresponding EM signatures to be synthesized.

Although the control parameters within each DA function are randomized during generation of the data augmentation transformation pool, they are bounded, e.g., having minimum and maximum limits, based on physical constraints which are informed by empirical data, the target 604 radar system operating range and Doppler resolution limits, and other application settings. For example, if the maximum range of the target 604 radar system is five meters (based on the radar system parameters) then, random variations that spatially shift any of the targets 604 beyond five meters from the radar are wasteful. One way to circumvent this problem is to set appropriate bounds on the control parameters and clip the generated target 604 distance values based on maximum plausible limits. In another example, in which the transformation is applied in the temporal domain to change the speed of the gesture, the maximum and minimum factor-of-change of the gesture speed may be informed by any empirical data, if available, or based on some reasonable expectations of the time required to perform the action.

The transformed trajectories are fed into an RCS model determined based on whether the rigid bodies are to be used in operation 1016. For example, if an RCS model based on rigid bodies is employed such as described above in FIGS. 9A-9D, the RCS orientation of each element, e.g., element orientation Pⱼ, as a projected area is determined in operation 1018 then fed into operation 1020 where the RCS is divided by the number of markers in the element orientation to obtain the RCS of each marker. Alternatively, if an RCS model is not based on rigid bodies, the RCS may be computed using a primitive model in operation 1022. For example, each element orientation may be modeled as an ellipsoid, plate, sphere, or other primitive shape for which closed-form RCS expressions are available. The RCS computation loop continues for each element, e.g., until j is equal to or greater than the total number of elements S, in operation 1024.

Once the number of elements threshold of operation 1024 is met, the EM scatter signals are synthesized at a receiver using an analytical model, such as a phasor sum of the EM signals from each element orientation in operation 1026. In operation 1028, if the total number of applied DA function transformations d is less than the cardinality of the DA functions D, the method 1000 returns to operation 1014 and again transforms the set of motion capture trajectories for processing in the RCS computation loop beginning with operation 1016. If total number of applied DA function transformations d is equal to or greater than the cardinality of the DA functions D, e.g., all DA functions of the transformation pool have been applied, the method 1000 proceeds to determine whether all gestures in the motion capture trajectories are read in operation 1030. If not, the method 1000 returns to operation 1006 to process any unread gestures. The method 1000 ends when all gestures in the motion capture trajectories are read.

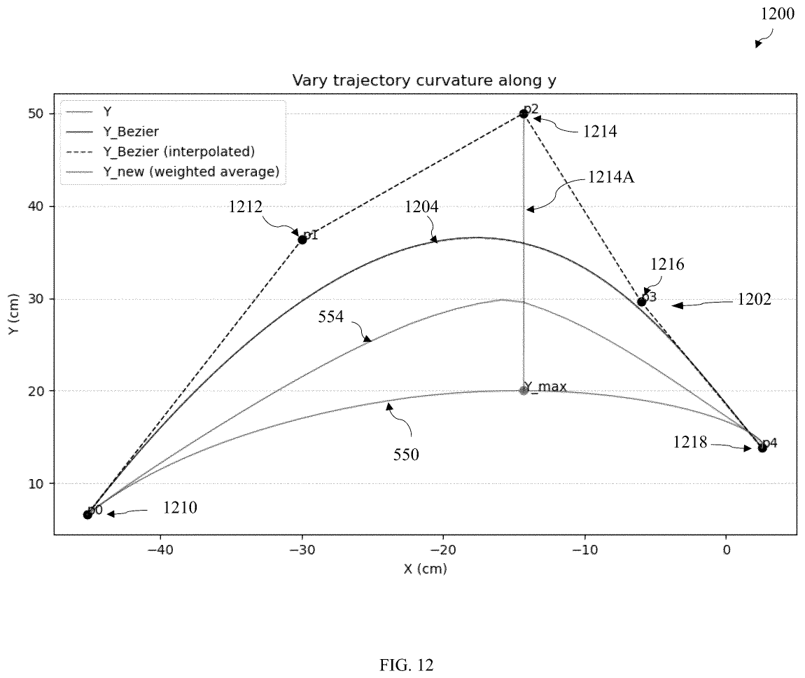

FIGS. 13A and 13B illustrate an example of a framework 1300 for constructing a data augmentation pipeline according to various embodiments of the present disclosure which may be executed by the gesture recognition and activity detection system 600. A framework 1300 for constructing the pool of data augmentation (DA) functions, e.g., a Data augmentation transformation pool 1330, to transform the plurality of sets of motion trajectories 552 is shown in FIGS. 13A and 13B. First, a token mapping process 1302 occurs as shown in FIG. 13A. For example, each DA function 1304, regardless of its transformation type, e.g., spatial, temporal, noise, is mapped to a function token 1306. Thus, a set of DA functions 1304 creates a set of function tokens 1306. Additionally, a combination of DA functions 1304 may be mapped to a single function token 1306 such that one function token 1306 may call a combination of two or more DA functions 1304. For example, mapping be performed using a list, each element of the list is a combination of one or more function tokens (at least some function tokens in the set of function tokens), to generate a data augmentation transformation pool. Second, a DA specification 1310 is used to specify the combination of DA functions to apply and how many times 1312 each combination is applied to the input original trajectory segment. Each line in the DA specification 1310 specifies the DA function 1304 or combinations of DA functions 1304 using the function tokens 1306 as shown in FIG. 13B. The DA specification 1310 can either be part of the configurations and settings file 1050 (FIG. 10) or a separate request file provided as input to the trajectory processing and EM synthesizer system. The DA pipeline builder 1320 parses the DA specification and builds a data augmentation transformation pool 1330 of DA functions 1304 and combinations of DA functions 1304 and finally applies each DA function 1304 combination in the data augmentation transformation pool 1330 to an original trajectory 1340 of the plurality of sets of motion trajectories 552, producing the set of data augmented motion trajectories 554 with as many transformed trajectories as specified in the DA specification 1310. For example, the data augmentation transformation pool 1330 is created and stored in computer memory as a list of lists, in which each inner list is a collection of DA function 1304 objects (a list can contain one or multiple function objects). As illustrated, this framework provides a way to efficiently create a very large set of possible DA transformation functions using a simple request. Additionally, tokenizing the functions, e.g., mapping the DA functions 1304 to the function tokens 1306, and the simple structure of specifying the number and type of transformation in the DA specification 1310 allow flexibility in the framework 1300.

Note that one of the DA functions 1304, for example, the function identified by DAF_0 in FIG. 13 may be an identity function 1304A. This identity function 1304A simply returns the original function without transforming it. Apart from the fact that the original trajectory 1340 is itself a point in the space of possible variations, the simulated radar signal generated from the original trajectory 1340 can be used to compare against the real radar signal if it is captured simultaneously with motion capture.

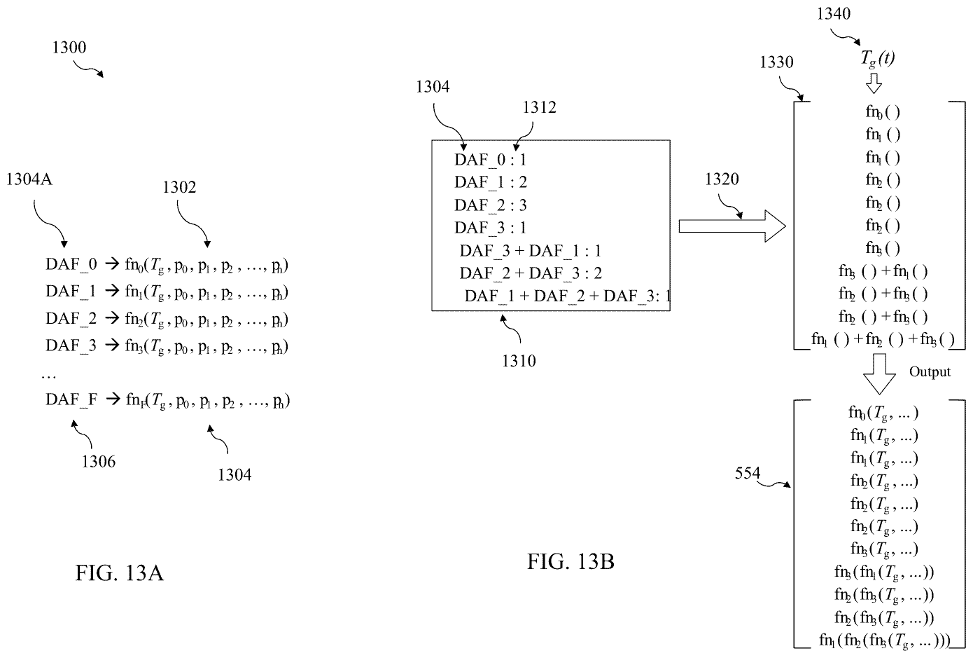

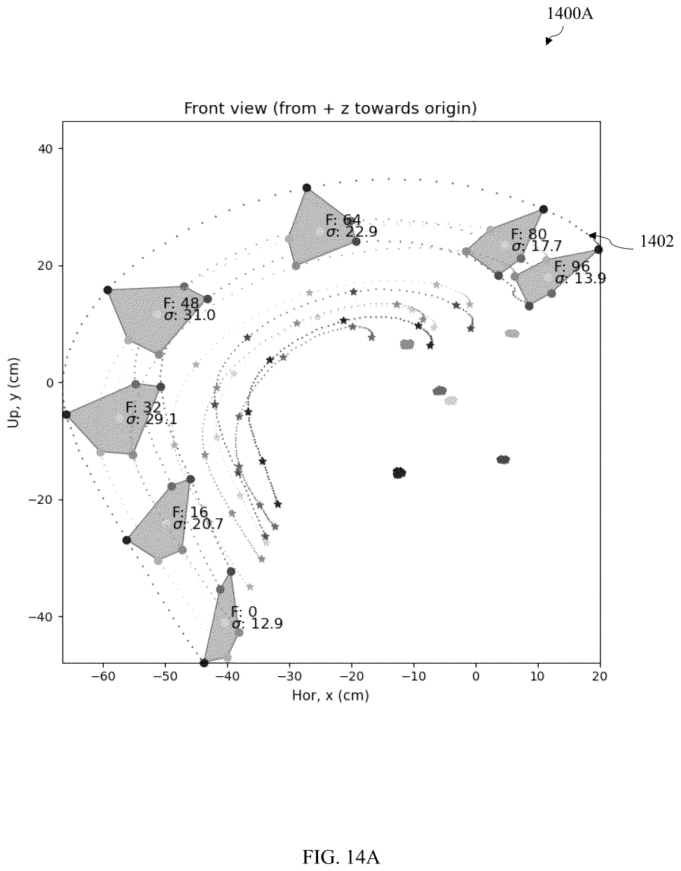

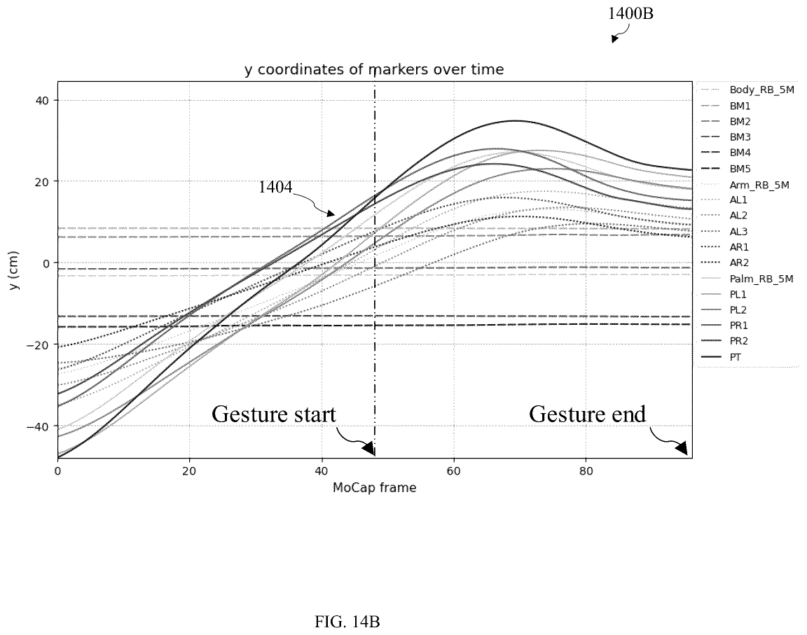

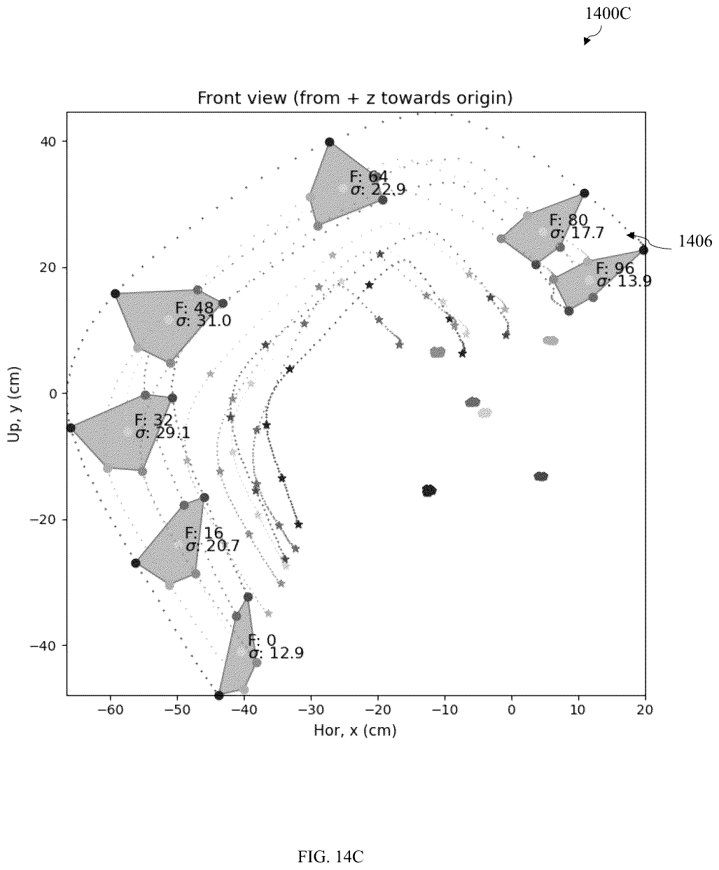

FIGS. 14A, 14B, 14C, and 14D illustrate an example of data augmentation which may be performed by the gesture recognition and activity detection system 600. In particular, data augmentation was applied to change the curvature of a left-to-right swipe hand gesture along a Y-axis. In this data augmentation function, only the trajectories of the set of data augmented motion trajectories 554 of the markers 602 related to the palm rigid body 610 and the forearm rigid body 612 were transformed leaving the trajectories of the markers 602 related to the torso in the data augmented set identical to the original. Furthermore, the transformation to change the curvature was applied only between the gesture start and end points. The palm rigid body trajectories 1402 are shown in FIG. 14A in a planar trajectory graph 1400A and the original trajectories 1404 are shown in FIG. 14B in a y-coordinate trajectory graph 1400B. FIGS. 10C and 10D, however, show an increase in the trajectory height, e.g., increase in y-direction, in the data augmented palm rigid body trajectories 1406 of the data augmented planar trajectory graph 1400C and the data augmented motion trajectories 1408 in data augmented y-coordinate trajectory graph 1400D when compared to the original trajectories of FIGS. 10A and 10B. Note that only the trajectories of the arm, e.g., markers 602 on a hand and arm, were transformed. The trajectories of the body markers 602 in the data augmented set remain identical to the original. Furthermore, the transformation to change the curvature was applied only between the gesture start and end points.

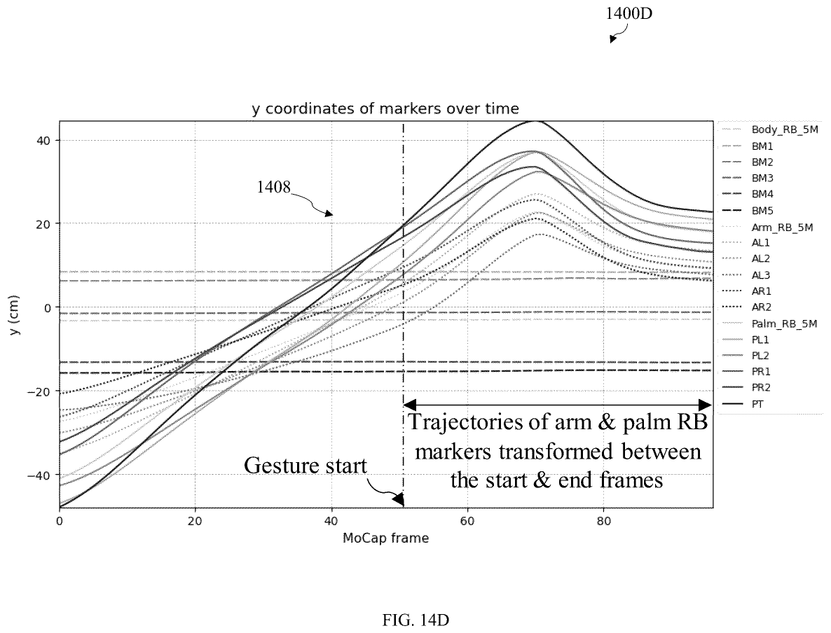

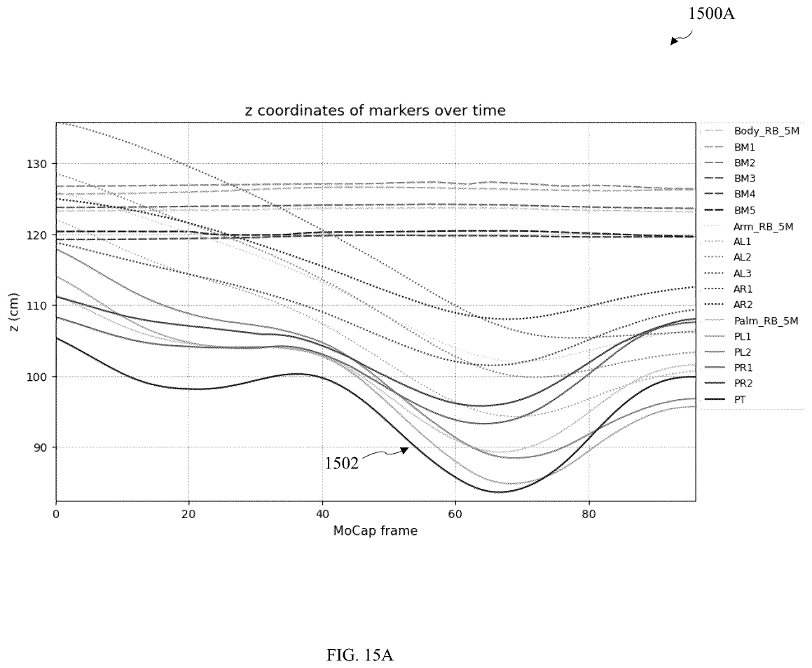

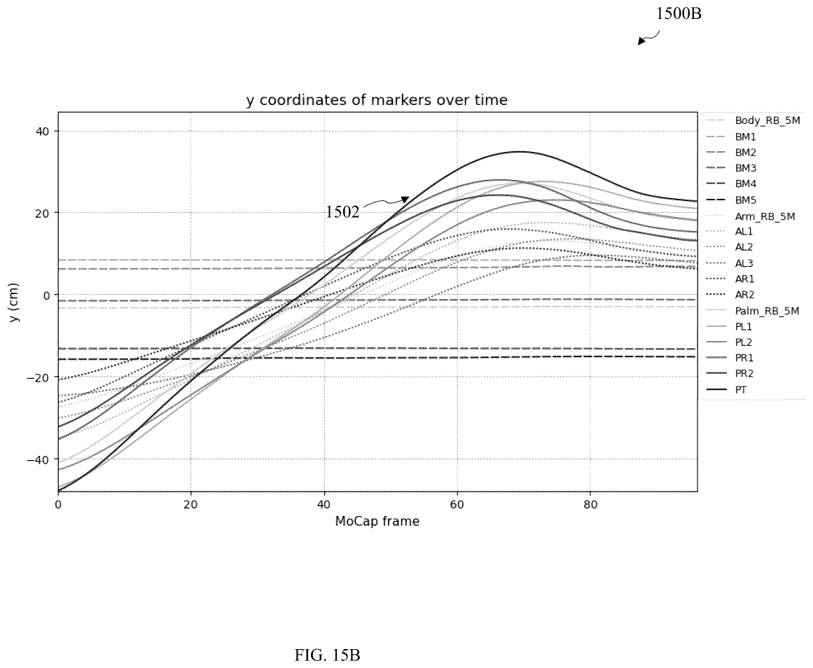

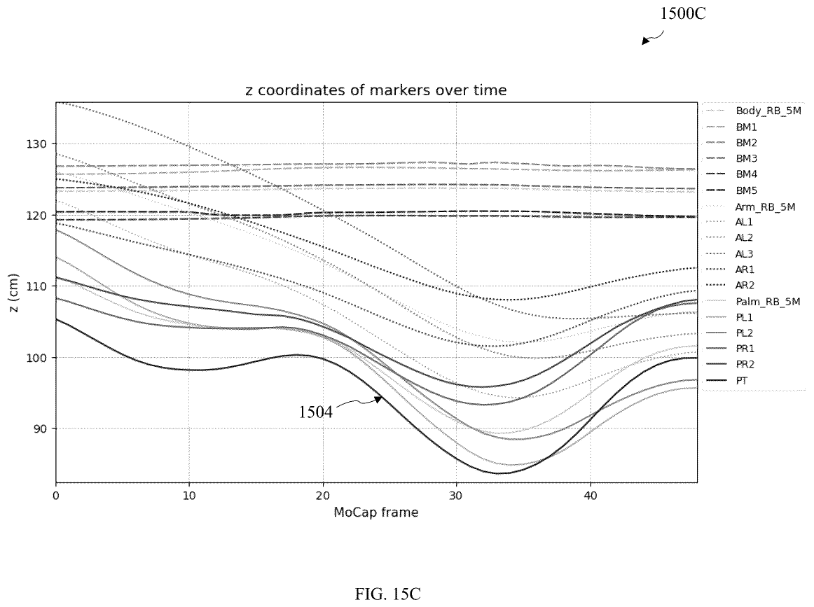

Similarly, FIGS. 15A, 15B, 15C, and 15D illustrates data augmentation to change the speed linearly, e.g., doubling the speed, of the swipe left to right hand gesture which may be performed by the gesture recognition and activity detection system 600. The curvature of the trajectories was unaffected. The original trajectories 1502 are shown in FIG. 15A in a y-coordinate trajectory graph 1500A and in a z-coordinate trajectory graph 1500B shown in FIG. 1B. FIGS. 15C and 15D, however, show a doubling of trajectory speed, e.g., significant decrease in x-direction, in the data augmented motion trajectories 1504 of the y-coordinate trajectory graph 1500C and in z-coordinate trajectory graph 1500D while maintaining the original trajectory shape.

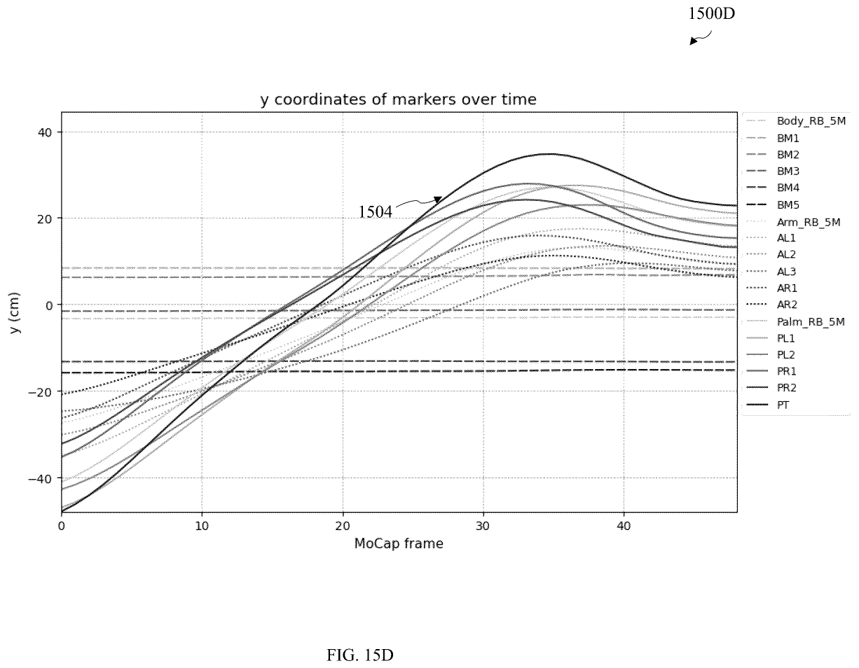

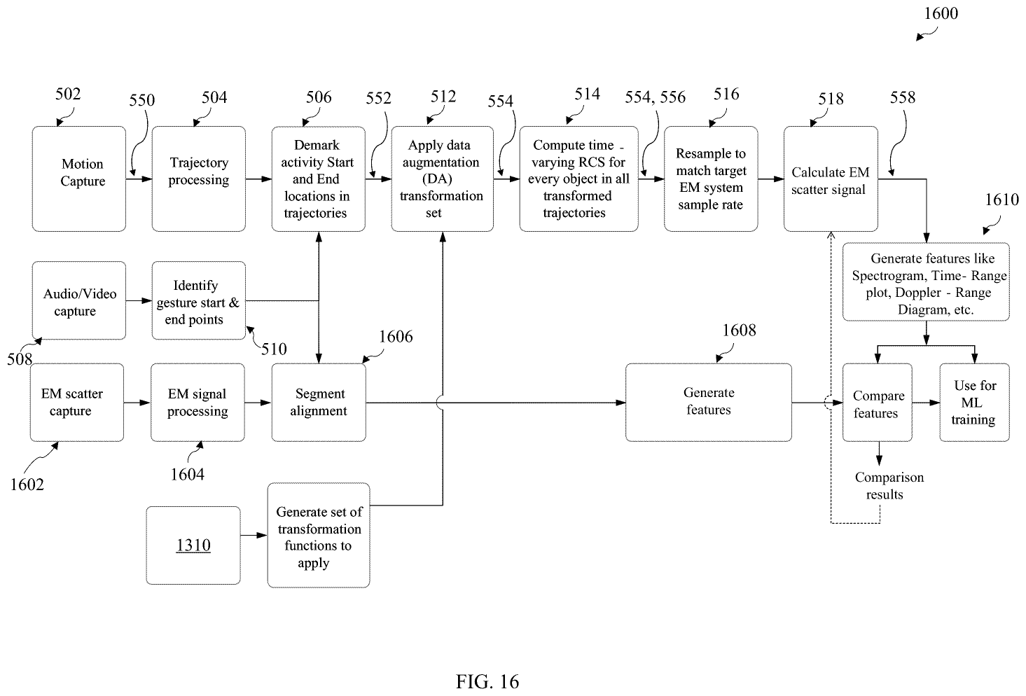

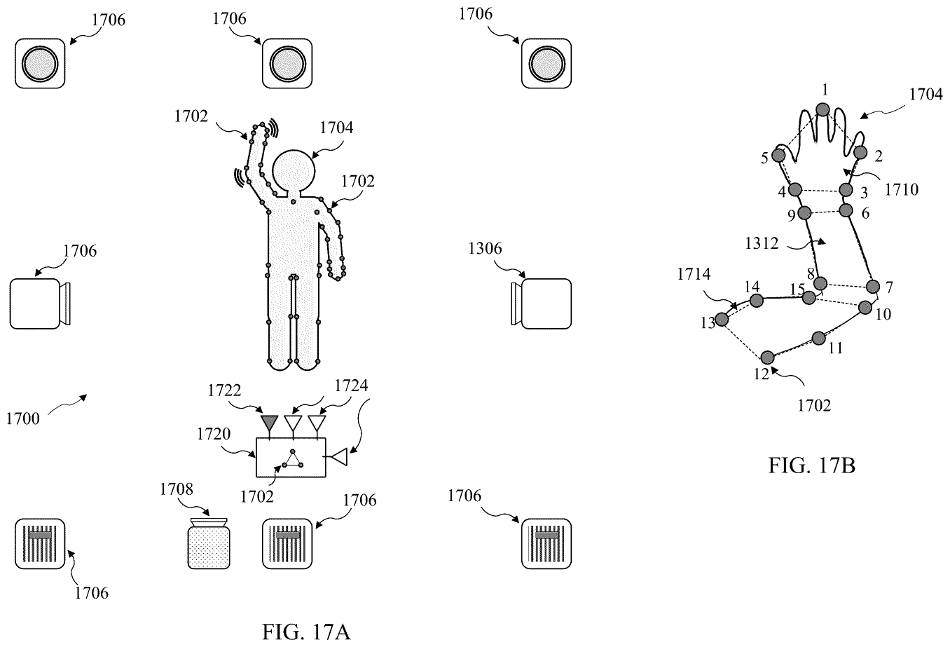

FIG. 16 illustrates an example of a flow chart for a method 1600 of generating a synthetic EM scatter signals encoding a variety of activities from motion capture trajectories according to various embodiments of the present disclosure which may be performed by the processor 224 of an electronic device, such as the gesture recognition and activity detection system. FIG. 17A illustrates an example of a gesture recognition and activity detection system 1700 for synchronously capturing activity motion trajectories concurrently with real EM signatures using a radio frequency (RF) module according to various embodiments of the present disclosure that may perform the method 1600 of FIG. 16. FIG. 17B illustrates an example of markers on a target for recording the motion trajectories used by the gesture recognition and activity detection system 1700 of FIG. 17A according to various embodiments of the present disclosure.

In an embodiment of this disclosure, real EM signature data, for example from mmWave frequency-modulated continuous wave radar Doppler signatures, may be simultaneously captured along with the motion capture of the performance of gesture and activity actions. A method 1600 including a sequence of processing steps is shown in FIG. 16. Note that most of the operations of the method 500 of FIG. 5 are included in the method 1600 of FIG. 16. Additionally, the method 1600 contains the operations for capturing (operation 1602), processing (operation 1604), and aligning (operation 1606) the real EM scatter signals containing the Doppler and micro-Doppler signatures of the activities. Additional audio/video capture may be used to identify the start and end points of activities. In operation 1606, the alignment process is used to align the real signal segments with the synthesized signal segments for comparison. The inputs to the alignment process are the information about the frame rates of the motion capture sub-system, radar sub-system, and the audio/video system (if used); capture start times of motion capture, radar, and audio/video (if used); the start and stop end points of activities; and empirically determined systemic time offsets/delays between motion capture and radar sub-systems (if any). If the motion capture, radar, and audio/video sub-systems are part of the same network, the network system clock may be used to represent the capture start times in each of these sub-systems. On the other hand, if they are in separate networks having independent clocks, then additional clock synchronization mechanisms such as using Network Time Protocol (NTP) may be used. In operation 1608, the real EM scatter signals, after processing and alignment, may be used to generate features for use as part of a ML algorithm configured for gesture recognition and activity detection.

The set of EM scatter signals 558 may be also used to generate features as part of a ML algorithm as shown in operation 1610. The real signals or some features generated from the real signals, such as a spectrogram, a TVD, or a TAD, may be used to compare the corresponding signals/features obtained from set of EM scatter signals 558. For such comparison, the position of the real radar may be obtained by adding markers on the real radar during capture or provided using the settings and configuration file (FIG. 10). During motion capture processing, the position of the virtual radar is set to match the position of the real radar. Furthermore, the synthesized EM signal from the motion capture trajectory corresponding to the identity data augmentation function (FIG. 17) is used for comparison against the ground truth real radar signal. Settings and parameters of the synthetic pipeline may be updated based on the outcome of such comparisons to improve the quality of synthetic data as needed. Furthermore, the small set of real radar data and the larger set of synthetic radar data may be used to improve the performance of ML models for gesture recognition and activity detection using domain adaptation techniques as discussed subsequently. Alternatively, apart from using techniques like domain adaptation, the synthetic data combined with real data may be used to create a large dataset for training ML-based algorithms for gesture and activity detection.

A gesture recognition and activity detection system 1700 for synchronously capturing the motion trajectories of activities and gestures along with real radar Doppler and micro-Doppler signatures is shown in FIG. 17. A set of motion capture cameras 1706, an infrared camera 1708, an RF module 1720, and audio/video (not shown) sub-systems are synchronized to record the activity performance simultaneously. The RF module 1720 includes a transmitter antenna 1722 and at least one receiver antenna 1724 (three shown) and is configured to send and receive radar signals corresponding to the markers 1702 of a target 1704.

Similar to the system 200 of FIGS. 6A and 2B, the system 1700, the target 604, e.g., human body parts such as the hand (or palm), the forearm, the upper arm, and the torso, are modeled as planar rigid bodies (RB) as shown in FIG. 17B. For example, a palm or hand rigid body 1710 includes markers 1702 numbered 1-5, a forearm rigid body 1712 includes markers 1702 numbered 6-9, and the upper arm rigid body 1714 includes markers 1702 numbered 10-15. Although not shown in the figure, the torso may also be modeled as a rigid body using of a set of markers 1702. Since each part of the body is modeled as rigid bodies, the group of markers 1702 belonging to a particular rigid body is constrained to remain in fixed positions with respect to each other.

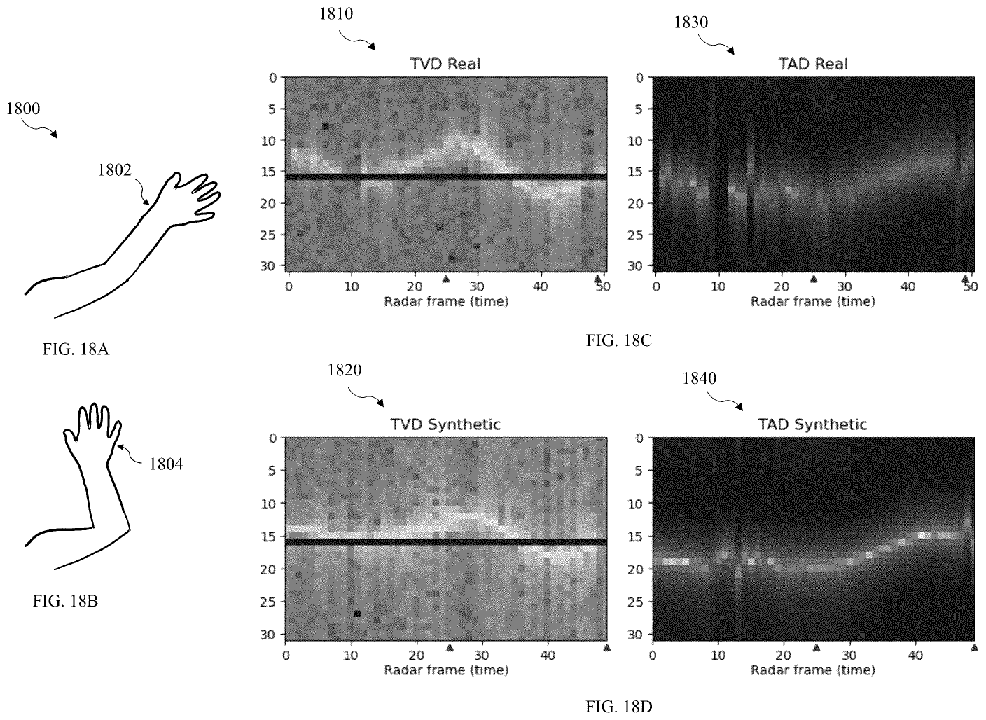

FIGS. 18A, 18B, 18C, and 18D illustrate an example of qualitative comparison of real and synthetic time-velocity diagram and time-angle diagram for a left-to-right swipe gesture according to various embodiments of the present disclosure which may be determined by the gesture recognition and activity detection system 1700. FIG. 18A illustrates a starting point 1802 of a left-to-right hand gesture 1800 captured by the gesture recognition and activity detection system 1700 of FIGS. 17A and 17B. FIG. 18B illustrates an ending point 1804 of the left-to-right hand gesture 1800. The TVD and TAD data for a left-to-right swipe hand gesture obtained from a real mmWave FMCW radar and the corresponding TVD and TAD data synthesized from motion capture (simultaneously captured) are shown in FIGS. 18C and 18D for qualitative comparison.

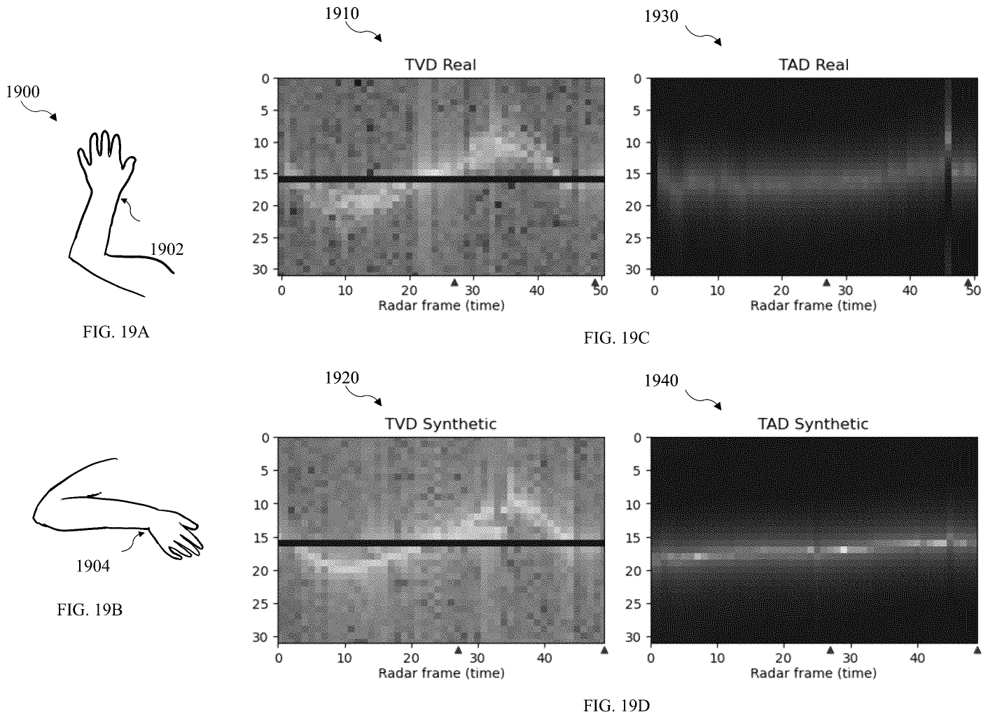

FIGS. 19A, 19B, 19C, and 19D illustrate an example of qualitative comparison of real and synthetic time-velocity diagram and time-angle diagram for a tap gesture according to various embodiments of the present disclosure which may be determined by the gesture recognition and activity detection system 1700. FIG. 19A illustrates a starting point 1902 of a tap gesture 1900. FIG. 19B illustrates an ending point 1904 of the tap gesture 1900. FIGS. 19C and 19D show a qualitative comparison of the real TVD 1910 and TAD 1930 (FIG. 19C) and synthesized TVD 1920 and TAD 1940 (FIG. 19D) for a tap hand gesture. As shown, there is a close match between the real and synthetic TADs 1810, 1830 and TVDs 1820, 1840 for the left-to-right hand gesture. Similarly, there is a close match between the real TVD 1910 and real TAD 1930 and synthetic TVD 1920 and synthetic TAD 1940 for the tap gesture.

The accuracy of supervised deep-learning models crucially depends on the availability of the quality and quantity of labeled training data. In the case of RF-based gesture recognition and activity detection problems, the real data collected by radar is scarce due to the cost of data acquisition. Domain adaptation is a technique to improve the performance of a model on a target domain containing insufficient annotated data by using the knowledge learned by the model from another related domain (source domain) with adequate labeled data. In an embodiment of this disclosure targeting mmWave gesture recognition, the source domain data is synthesized data that can be easily generated using the data augmentation and simulation pipeline. And the target domain data is the real data collected by radar.

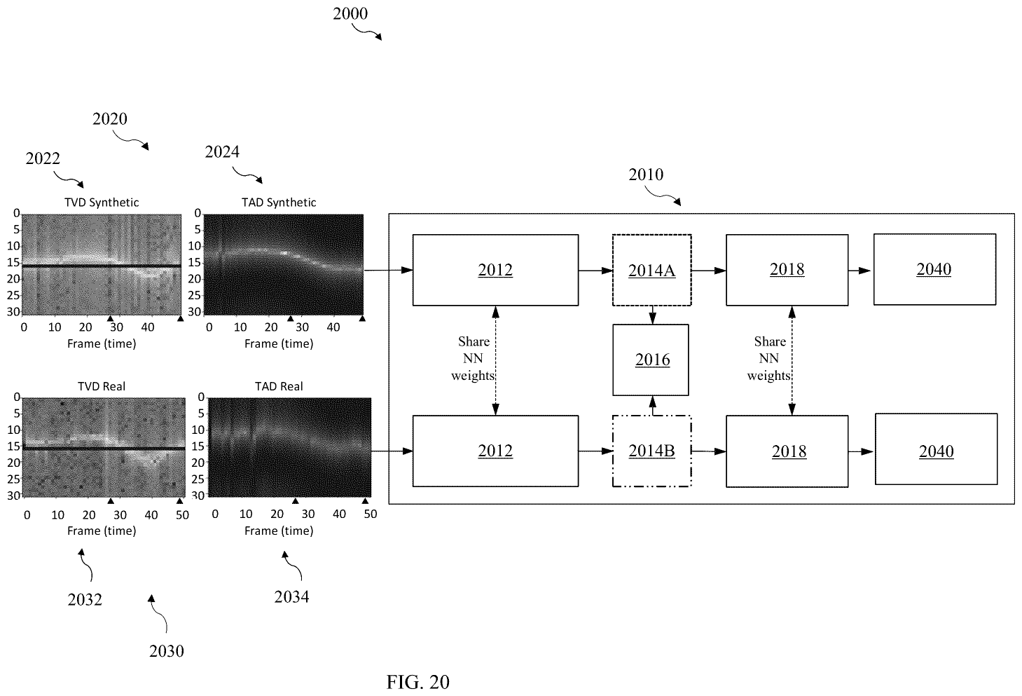

FIG. 20 illustrates an example of a flow chart for a domain adaptation process using synthesized data from a data augmentation process according to various embodiments of the present disclosure for use in a gesture recognition and activity detection system, e.g., the system 1700. In this embodiment, a neural network 2010 is initially trained by the source domain data 2020 for classification. The source domain data 2020 includes synthesized TVD 2022 and TAD 2024 data generated from the synthesized radar data obtained from the data augmentation and simulation pipeline, e.g., using method 1300 of FIG. 13. The neural network 2010 comprises a feature generation layer 2012 and a classification layer 2018. Next, the source domain data 2020 and target domain data 2030 having real TVD 2032 and TAD 2034 data are paired and input to the neural network 2010 for domain adaptation training. For a pair of input data, e.g., one from the source domain data 2020 and one from the target domain data 2030, the feature generation layer 2012 is used to extract features for both sets of data, e.g., a source domain feature 2014A and a target domain feature 2014B, and the distance between those two features is calculated and recorded as part of the total training loss, e.g., feature distance loss 2016. Those extracted features, the source domain feature 2014A and the target domain feature 2014B, are then input to the classification layer 2018 to output predictions. A classification loss 2040 is calculated by comparing predictions with true labels. Finally, the neural network 2010 weights are updated by minimizing the feature distance loss 2016 and classification loss 2040. In this way, the neural network 2010 is encouraged to find domain-invariant features for input data improving its performance in the target domain as well.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A computer-implemented method comprising:
receiving motion capture data of a target from a camera;
generating a first set of motion trajectories from the motion capture data;
generating a first set of augmented motion trajectories using a set of data augmentation functions on the first set of motion trajectories;
generating a radar cross-section of the target using the motion capture data to perform at least one of gesture recognition or activity detection;
generating one or more synthetic electromagnetic (EM) signatures of one or more activities of the target using the first set of augmented motion trajectories and the radar cross-section; and
training a machine learning model configured for EM signature-based gesture recognition or activity detection with a domain adaptation process using the one or more synthetic EM signatures.

2. The method of claim 1, wherein the domain adaptation process uses simulated EM signatures of data-augmented motion trajectories and a set of real EM signatures.

3. The method of claim 1, wherein generating the first set of augmented motion trajectories using the set of data augmentation functions on the first set of motion trajectories comprises:
mapping each data augmentation function of the set of data augmentation functions to a function token to create a set of function tokens;
using the set of function tokens to generate a data augmentation transformation pool; and
applying the data augmentation transformation pool to the first set of motion trajectories.

4. The method of claim 3, wherein parameters of each of the data augmentation functions are randomized during generation of the data augmentation transformation pool, the randomization of the parameters being bounded based on physical constraints.

5. The method of claim 3, further comprising using a data augmentation specification with the set of function tokens to generate the data augmentation transformation pool, wherein the data augmentation specification contains a random control parameter and instructions for a number of times to apply each token and combination of tokens of the set of function tokens.

6. The method of claim 1, wherein:
the radar cross-section is a time-varying radar cross-section of the target, and
the time-varying radar cross-section is input into an EM scattering signal model to generate the one or more synthetic EM signatures.

7. The method of claim 1, wherein generating a radar cross-section of the target using the motion capture data to perform at least one of gesture recognition or activity detection comprises:
grouping markers to create at least one marker group, wherein the at least one marker group is approximated as at least one planar target and each marker includes a position in the at least one planar target;
determining a unit normal vector of the at least one planar target based on the positions of the markers in the at least one planar target;
determining a projected angle of the at least one planar target with respect to a radar axis of a virtual radar direction; and
generating the radar cross-section of the target using the projected angle as input.

8. An electronic device, comprising:
a processor, configured to:
receive motion capture data of a target;
generate a first set of motion trajectories from the motion capture data;
generate a first set of augmented motion trajectories using a set of data augmentation functions on the first set of motion trajectories;
generate a radar cross-section of the target using the motion capture data to perform at least one of gesture recognition or activity detection;
generate one or more synthetic electromagnetic (EM) signatures of one or more activities of the target using the first set of augmented motion trajectories and the radar cross-section; and
train a machine learning model configured for EM signature-based gesture recognition or activity detection with a domain adaptation process using the one or more synthetic EM signatures.

9. The electronic device of claim 8, wherein to generate the first set of augmented motion trajectories using the set of data augmentation functions on the first set of motion trajectories, the processor is further configured to:
map each data augmentation function of the set of data augmentation functions to a function token to create a set of function tokens;
use the set of function tokens to generate a data augmentation transformation pool; and
apply the data augmentation transformation pool to the first set of motion trajectories.

10. The electronic device of claim 9, wherein parameters of each of the data augmentation functions are randomized during generation of the data augmentation transformation pool, the randomization of the parameters being bounded based on physical constraints.

11. The electronic device of claim 9, wherein:
the processor is further configured to use a data augmentation specification with the set of function tokens to generate the data augmentation transformation pool,
wherein the data augmentation specification contains a random control parameter and instructions for a number of times to apply each token and combination of tokens of the set of function tokens.

12. The electronic device of claim 8, wherein:
the radar cross-section is a time-varying radar cross-section of the target, and
the time-varying radar cross-section is input into an EM scattering signal model to generate the one or more synthetic EM signatures.

13. The electronic device of claim 8, wherein the domain adaptation process uses simulated EM signatures of data-augmented motion trajectories and a set of real EM signatures.

14. The electronic device of claim 8, wherein to generate the radar cross-section of the target using the motion capture data to perform at least one of gesture recognition or activity detection, the processor is further configured to:
group markers to create at least one marker group, wherein the at least one marker group is approximated as at least one planar target and each marker includes a position in the at least one planar target;
determine a normal axis of the at least one planar target based on the positions of the markers in the at least one planar target;
determine a projected angle of the at least one planar target with respect to a radar axis of a virtual radar direction; and
generate the radar cross-section of the target using the projected angle as input.

15. A non-transitory computer-readable medium comprising program code, that when executed by at least one processor of an electronic device, causes the electronic device to:
receive motion capture data of a target from a camera;
generate a first set of motion trajectories from the motion capture data;
generate a first set of augmented motion trajectories using a set of data augmentation functions on the first set of motion trajectories;
generate a radar cross-section of the target using the motion capture data to perform at least one of gesture recognition or activity detection;
generate one or more synthetic electromagnetic (EM) signatures of one or more activities of the target using the first set of augmented motion trajectories and the radar cross-section; and
train a machine learning model configured for EM signature-based gesture recognition or activity detection with a domain adaptation process using the one or more synthetic EM signatures.

16. The non-transitory computer-readable medium of claim 15, wherein the program code, that when executed by the at least one processor, causes the electronic device to generate the first set of augmented motion trajectories using the set of data augmentation functions on the first set of motion trajectories, comprises program code, that when executed by the at least one processor, causes the electronic device to:
map each data augmentation function of the set of data augmentation functions to a function token to create a set of function tokens;
use the set of function tokens to generate a data augmentation transformation pool; and
apply the data augmentation transformation pool to the first set of motion trajectories.

17. The non-transitory computer-readable medium of claim 16, further comprising program code, that when executed by the at least one processor, causes the electronic device to:
use a data augmentation specification with the set of function tokens to generate the data augmentation transformation pool, wherein the data augmentation specification contains a random control parameter and instructions for a number of times to apply each token and combination of tokens of the set of function tokens.

18. The non-transitory computer-readable medium of claim 16, further comprising program code, that when executed by the at least one processor, causes the electronic device to randomize parameters of each of the data augmentation functions during generation of the data augmentation transformation pool, the randomization of the parameters being bounded based on physical constraints.

19. The non-transitory computer-readable medium of claim 15, comprising program code, that when executed by the at least one processor, causes the electronic device to:
vary the radar cross-section of the target over time; and
input the time-varying radar cross-section into an EM scattering signal model to generate the one or more synthetic EM signatures.

20. The non-transitory computer-readable medium of claim 15, wherein the program code, that when executed by the at least one processor, causes the electronic device to generate a radar cross-section of the target using the motion capture data to perform at least one of gesture recognition or activity detection, comprises program code, that when executed by the at least one processor, causes the electronic device to:
group markers to create at least one marker group, wherein the at least one marker group is approximated as at least one planar target and each marker includes a position in the at least one planar target;
determine a normal axis of the at least one planar target based on the positions of the markers in the at least one planar target;
determine a projected angle of the at least one planar target with respect to a radar axis of a virtual radar direction; and
generate the radar cross-section of the target using the projected angle as input.
